(19) United States
(12) Patent Application Publication
(10) Pub. No.: US 2018/0055002 A1
(43) Pub. Date: Mar. 1, 2018

(54) ANIMAL LITTER SYSTEM

(71) Applicant: Georgia-Pacific LLC, Atlanta, GA (US)

(72) Inventors: Michael E. Carroll, Loganville, GA (US); Ronald C. Norris, Loganville, GA (US); Robert W. Burkhardt, Dacula, GA (US); John P. Kelly, Sugar Hill, GA (US); Steven Frazier, Stockbridge, GA (US)

(73) Assignee: Georgia-Pacific LLC, Atlanta, GA (US)

(21) Appl. No.: 15/565,303

(22) PCT Filed: Apr. 10, 2016
(86) PCT No.: PCT/US2016/026848

§ 371 Date: Oct. 9, 2017

Related U.S. Application Data
(60) Provisional application No. 62/146,238, filed on Apr. 10, 2015.

(51) Int. Cl. A01K 1/01; A01K 1/03

(52) U.S. Cl. CPC A01K 1/0107; A01K 1/033

(57) ABSTRACT

An animal litter system can include a housing unit and a removable cartridge containing litter. The housing unit can include housing walls, a floor, and a lid at least partially enclosing an interior volume. An interior wall can be disposed in the housing unit and can divide the interior volume into first and second compartments. A first passageway can be defined by a housing wall to provide access between the first compartment and outside of the housing unit. A second passageway can be defined by the interior wall to provide access between the first and second compartments. The removable cartridge can be disposed in the second compartment and can include a plurality of cartridge walls and a bottom at least partially enclosing an interior volume. Each of the plurality of cartridge walls and the bottom of the removable cartridge can independently include a plastic, cellulosic fibers, or a mixture thereof.

### CROSS-REFERENCE TO RELATED APPLICATION

This is a National Stage application under 35 U.S.C. § 371 of PCT/US2016/026848, filed on Apr. 10, 2016, and published as WO 2016/164868, which claims priority to U.S. Provisional Patent Application No. 62/146,238, filed on Apr. 10, 2015, which are both incorporated by reference herein.

### BACKGROUND

### Field

Embodiments described generally relate to animal litter systems. More particularly, such embodiments relate to animal litter systems that can include a housing unit and a removable cartridge containing litter, such as cat litter.

### Description of the Related Art

Cat litter boxes are frequently used by cat owners to provide a location for a cat to dispose of liquid and/or solid excrement wastes while in a human habitat such as a house. Often, the cat litter box is left on an interior floor of the human habitat. The litter box is usually filled with a litter material that absorbs and adheres to the excrement waste to form clumps of waste material. The litter material also reduces foul odors derived from the excrement waste. The cat owner can remove the waste clumps while leaving unused litter material for future use by the cat.

While in the litter box, the litter material can become entrained on or stuck to a cat's fur and paws. Often, when the cat leaves the litter box, the cat carries litter material out of the litter box where the litter material can become dislodged and spread to areas outside of the litter box, such as across the surface of the floor. Some cats have a tendency to leap out of the litter box, which action spreads even more litter material than from cats that exit the litter box with a slower and less aggressive movement. Occasionally, clumps of excrement waste can accompany the cat and further contaminate the surface of the floor. The litter and waste materials produce a mess across the surface of the floor in the human habitat and can pose an unsanitary environment and a potential health risk to the cat owner and/or other occupants of the human habitat.

There is a need, therefore, for an animal litter system that reduces or prevents the distribution of litter material and/or excrement waste outside of the animal litter system.

### SUMMARY

Animal litter systems are provided. In some examples, the animal litter system can include a housing unit and a removable cartridge containing litter. The housing unit can include housing walls, a floor, and a lid at least partially enclosing an interior volume of the housing unit. An interior wall can be disposed in the housing unit and can divide the interior volume into a first compartment and a second compartment. Each of the housing walls, the floor, the lid, and the interior wall of the housing unit can independently include one or more plastics, cellulosic fibers, or a mixture thereof. A first passageway can be defined by a first housing wall to provide access between the first compartment and outside of the housing unit through the first housing wall. A second passageway can be defined by the interior wall to provide access between the first compartment and the second compartment through the interior wall. The removable cartridge can include a plurality of cartridge walls and a bottom at least partially enclosing an interior volume of the removable cartridge. Each of the plurality of cartridge walls and the bottom of the removable cartridge can independently include one or more plastics, cellulosic fibers, or a mixture thereof. The litter can be disposed in the interior volume of the removable cartridge. The removable cartridge can be configured to be disposed in the second compartment in the housing unit.

In other examples of the animal litter system, the plurality of housing walls can be coupled to and extend from the floor. The plurality of housing walls and the floor can at least partially enclose the interior volume of the housing unit. The second passageway can include a threshold that can have a height of about 10 mm to about 150 mm extending from the floor of the housing unit.

In other examples of the animal litter system, the removable cartridge can include the plurality of cartridge walls and the bottom at least partially enclosing an interior volume of the removable cartridge. Each of the plurality of cartridge walls and the bottom can independently include one or more plastics. The removable cartridge can have a volume capacity of about 5 L to about 20 L.

### BRIEF DESCRIPTION OF THE DRAWINGS

FIG. 1 depicts a perspective view of an animal litter system, according to one or more embodiments described.

FIG. 2 depicts a cross-sectional view of the animal litter system illustrated in FIG. 1 taken along line 2-2.

FIG. 3 depicts a top, isometric view of the animal litter system illustrated in FIG. 1 having an opened housing unit and an opened removable cartridge.

FIG. 4 depicts a bottom, perspective view of the housing unit illustrated in FIGS. 1-3.

FIG. 5 depicts a top, perspective view of the removable cartridge illustrated in FIGS. 1-3.

FIG. 6 depicts a perspective view of another animal litter system, according to one or more embodiments described.

FIG. 7 depicts a cross-sectional view of the animal litter system illustrated in FIG. 6 taken along line 7-7.

FIG. 8 depicts a top, isometric view of the animal litter system illustrated in FIG. 6 having an opened housing unit and an opened removable cartridge.

FIG. 9 depicts a bottom, perspective view of the housing unit illustrated in FIGS. 6-8.

FIG. 10 depicts a top, perspective view of the removable cartridge illustrated in FIGS. 6-8.

### DETAILED DESCRIPTION

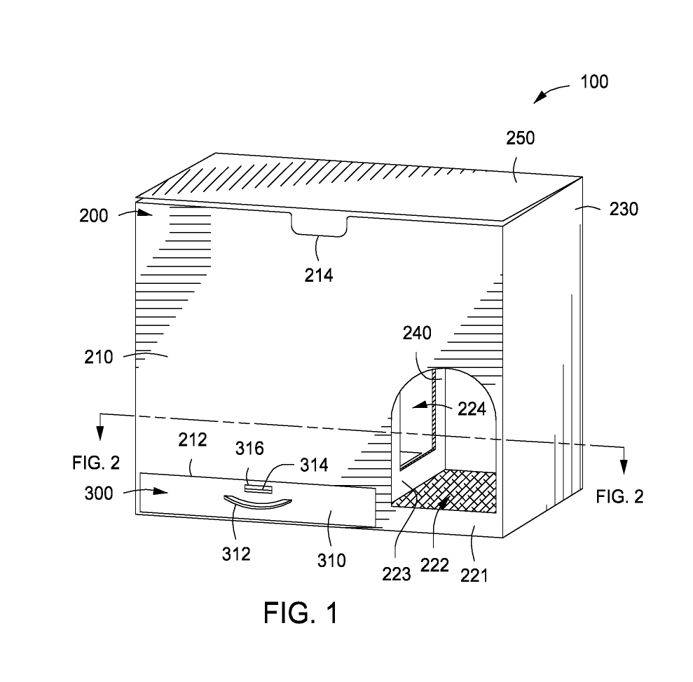

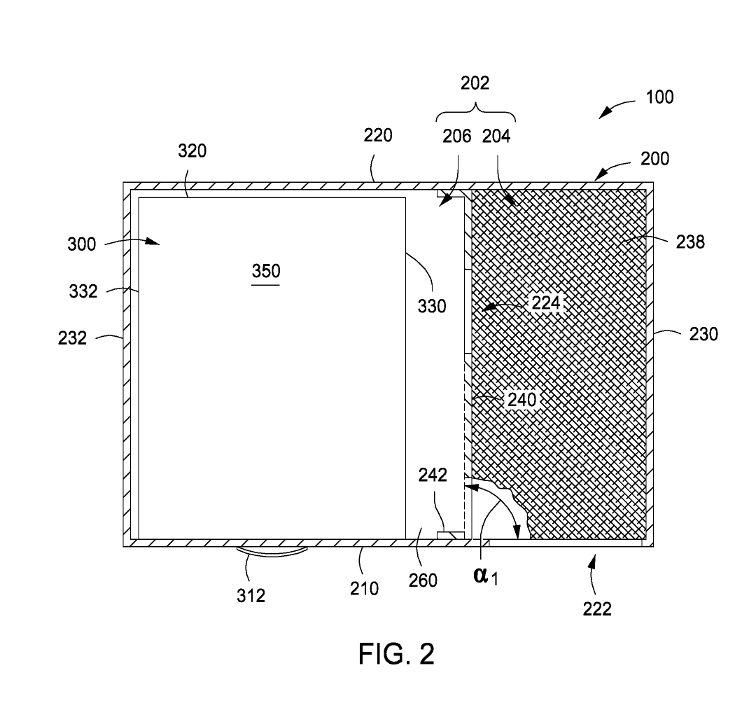

FIG. 1 depicts an animal litter system 100 that can include a housing unit 200 and a removable cartridge 300 and FIG. 2 depicts a cross-sectional view of the animal litter system 100 taken along line 2-2. The housing unit 200 can include a plurality of housing walls (four are shown 210, 220, 230, 232), a floor 260, and a lid 250 at least partially or substantially enclosing an interior volume 202 of the housing unit 200. One or more interior walls 240 can be disposed in the housing unit 200. As depicted in FIGS. 1 and 2, the interior wall 240 can divide, partition, or otherwise separate the interior volume 202 of the housing unit 200 into two or more compartments, such as a first compartment 204 and a second compartment 206.

One or more passageways, such as a first passageway 222 and a second passageway 224, can be defined by or otherwise formed in any of the housing walls 210, 220, 230, 232 and/or the interior wall 240. As depicted in FIGS. 1 and 2, the first passageway can be defined by or otherwise formed in the housing wall 210 and the second passageway 224 can be defined by or otherwise formed in the interior wall 240. The passageways 222, 224 can provide an animal access to and from the various portions of the interior volume 202 of the housing unit 200. For example, the passageway 222 can provide access between an outside or exterior location of the housing unit 200 to the first compartment 204 through the housing wall 210. The second passageway 224 can provide access between the first compartment 204 and the second compartment 206 through the interior wall 240.

One or more openings, such as an opening 212, can be defined by or otherwise formed in any of the housing walls 210, 220, 230, 232 and/or the floor 260. The opening 212 can provide a passageway to install and remove the removable cartridge 300 at least partially into or from the interior volume 202 of the housing unit 200. For example, the opening 212 can provide access between the outside of the housing unit 200 and the second compartment 206 through the front housing wall 210, as depicted in FIGS. 1 and 2. In some examples, not shown, the opening 212 can be defined by or otherwise formed in the back housing wall 220 or the side housing wall 232 and can provide access therethrough between the outside of the housing unit 200 and the second compartment 206. In other examples, not shown, the opening 212 can be defined by or otherwise formed in the floor 260 and can provide access between the outside of the housing unit 200 and the second compartment 206 via the floor 260. In this latter configuration, the housing unit 200 can be lifted away from the removable cartridge 300 that stays on the underlying surface (e.g., flooring surface).

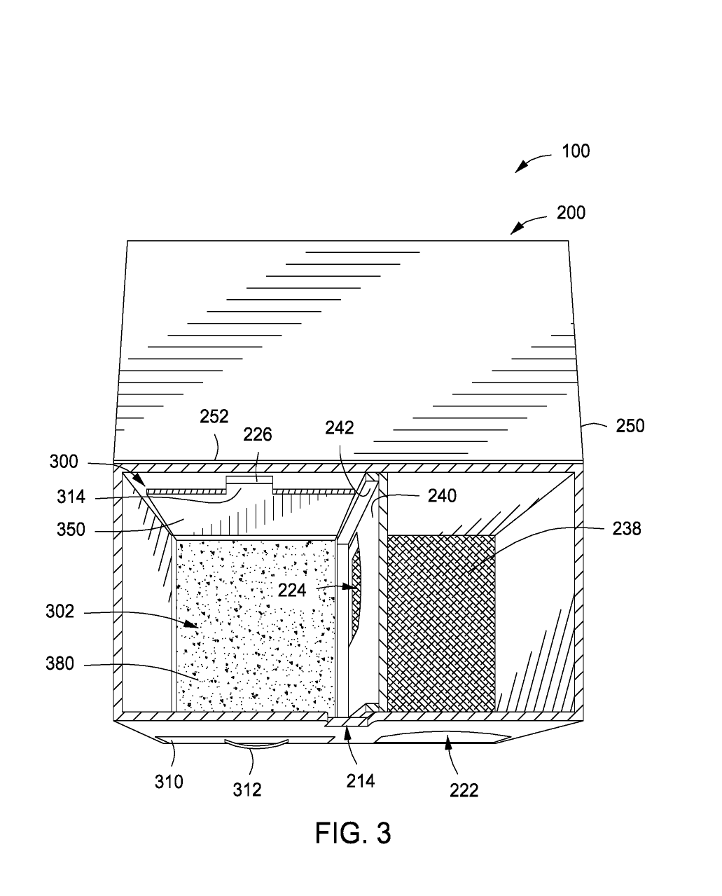

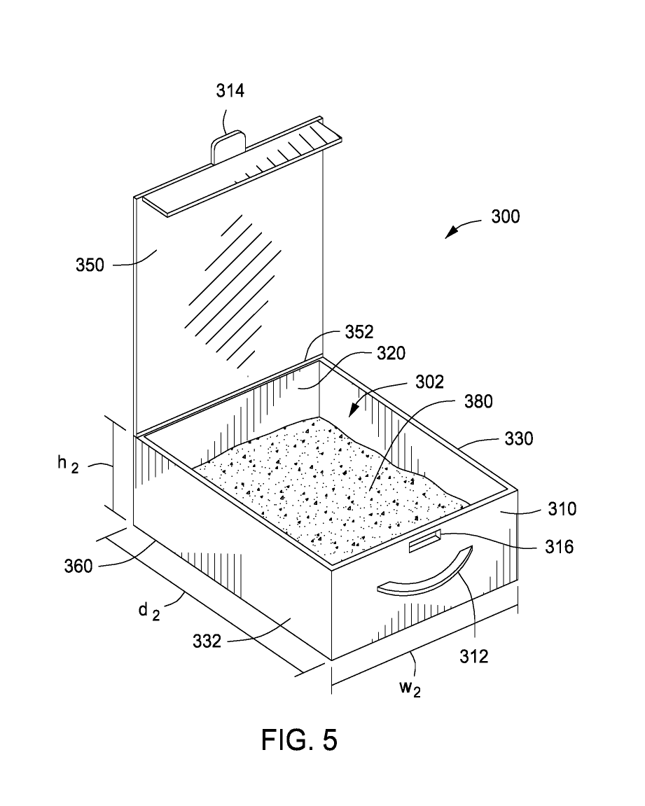

FIG. 2 further depicts that the removable cartridge 300 can include a plurality of cartridge walls 310, 320, 330, 332, and a top 350. The top 350 of the removable cartridge 300 can include one or more locking tabs 314 configured to insert into one or more locking slots 316 disposed through one or more of the cartridge walls 310, 320, 330, 332 when the top 350 is in a closed-position, as depicted in FIGS. 1 and 2. The cartridge walls 310, 320, 330, 332, the top 350, and a bottom 360 can at least partially, substantially, or completely enclose an interior volume 302 (as depicted in FIGS. 3 and 5) of the removable cartridge 300. Litter material, such as animal litter, can be disposed in the interior volume 302 of the removable cartridge 300.

One or more handles 312 can be disposed on one or more of the cartridge walls 310, 320, 330, 332. For example, the handle 312 can be disposed on an outer surface of the cartridge wall 310, as depicted in FIGS. 1 and 2. Alternatively, although not shown, one or more handles 312 can be defined by or otherwise formed in any of the cartridge walls 310, 320, 330, 332. The removable cartridge 300 can be configured to be disposed in the second compartment 206. Once disposed or otherwise placed in the second compartment 206, the handle 312 can extend from the outer surface of the cartridge wall 310. The handle 312 can be configured to be pulled for moving the removable cartridge 300 between the second compartment 206 and the outside of the housing unit 200 via the opening 212.

FIG. 3 depicts a top, isometric view of the animal litter system 100 that has the lid 250 opened on the housing unit 200. The lid 250 of the housing unit 200 can be coupled to any of the housing walls 210, 220, 230, 232 by one or more hinges 252. The hinge 252, if a fold, can be formed in the paperboard or other material that is used to make the lid 250 and at least the housing walls 210, 220, 230, or 232 coupled thereto. For example, the lid 250 can be coupled to the housing wall 220 via a fold as the hinge 252, as depicted in FIG. 3. Alternatively, other types of hinges, not shown, could be coupled to the lid 250 and the respective housing wall 210, 220, 230, or 232 that the lid 250 is coupled thereto. Alternatively, the lid 250 can lack any hinge (not shown) and can be resting on and not coupled to the housing walls 210, 220, 230, 232. For example, the lid 250 can be a separate piece of the remaining of the housing unit 200 and can be disposed or otherwise placed on the housing walls 210, 220, 230, 232 to cover the first compartment 204 and the second compartment 206, not shown. In one example, a paperboard or plastic flap or tab can be adhered to both the lid 250 and the housing wall 210, 220, 230, or 232. In another example, a paperboard flap or tab can be an integral portion of one of the lid 250 or the housing wall 210, 220, 230, or 232 and can be coupled to the other. In another example, a metal or plastic pinned hinge can be adhered to both the lid 250 and the housing wall 210, 220, 230, or 232.

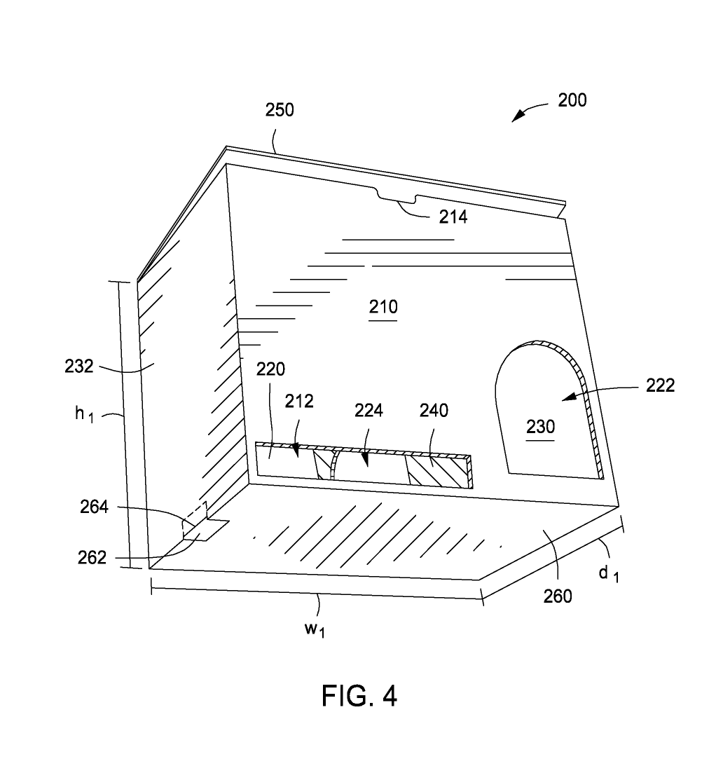

FIG. 4 depicts a bottom, perspective view of the housing unit 200. The plurality of housing walls 210, 220, 230, 232 can be coupled to and extend from the floor 260 to the lid 250—when the lids in a closed-position. The housing unit 200 can include any number of pairs of locking tabs and locking slots. For example, a locking tab 262 can be disposed on the floor 260 and a corresponding locking slot 264 can be defined by or otherwise formed in the sidewall 232. One or more locking tabs 262 and/or one or more locking slots 264 can be disposed on or defined by any of the housing walls 210, 220, 230, 232, the interior wall 240, the lid 250, and/or the floor 260. The locking tabs 262 and the locking slots 264 can be used to couple any two of the housing walls 210, 220, 230, 232, the interior wall 240, the lid 250, or the floor 260 together.

In some examples, the plurality of housing walls 210, 220, 230, 232 can include a front housing wall 210, a back housing wall 220, and at least one side housing wall 230, 232. The housing unit 200 can be configured to have the front housing wall 210, the back housing wall 220, and at least one side housing wall 230 or 232. The interior wall 240 can be coupled to at least one of the housing walls 210, 220, 230, 232 and/or the floor 260.

In one example, the interior wall 240 can be coupled to the front housing wall 210, the back housing wall 220, or both of the front housing wall 210 and the back housing wall 220. As depicted in FIGS. 2 and 3, a flap 242 can be adhered to one end of the interior wall 240 and the front housing wall 210 and another flap 242 can be adhered to the other end of the interior wall and the back housing wall 220. The flaps 242 can also be known as glue flaps or tabs. One or more adhesives or glues can be disposed on the flaps 242, the front housing wall 210, and/or the back housing wall 220 for adhering the interior wall 240 thereto. In another example, not shown, the interior wall 240 can be coupled to the side housing wall 230, the side housing wall 232, or both of the side housing walls 230, 232. In another example, not shown, the interior wall 240 can be coupled to the floor 260. The flap 242 can be located within the first compartment 204 or the second compartment 206. If interior wall 240 includes two or more flaps 242, the flaps 242 can be located in the first compartment 204, the second compartment 206, or some of the flaps, e.g., one, can be located in the first compartment 204 and some of the flaps 242, e.g., one, can be located in the second compartment 206.

The lid 250 can be coupled to one or more of the housing walls 210, 220, 230, 232. In some examples, the lid 250 can be coupled to any one of the housing walls 210, 220, 230, 232, while not being coupled to any of the remaining walls of the plurality of housing walls 210, 220, 230, 232. For example, the lid 250 can be coupled to the back housing wall 220 and can be not coupled to the front housing wall 210 or the side housing walls 230, 232, as depicted in FIGS. 1 and 3. In other examples, not shown, the lid 250 can be coupled to any two, any three, or all four of the housing walls 210, 220, 230, 232. For example, the lid 250 can be affixed or otherwise coupled to all four of the housing walls 210, 220, 230, 232 and an optional opening or flap can be defined by or otherwise formed in the lid 250.

FIGS. 1, 3, and 4 depict a gap 214 defined by an upper edge of the front housing wall 210. One or more gaps 214 can be defined by or otherwise formed in the upper edge of any of the housing walls 210, 220, 230, 232. The lid 250 can be configured to open away from the one or more gaps 214. For example, a person can open the lid 250 on the housing unit 200 by inserting the user's fingers or hand into the gap 214 and lifting the lid 250. In some examples, each of the front housing wall 210, one of the side housing walls 230, 232, and/or both of the side housing walls 230, 232 can independently have the gap 214.

FIG. 5 depicts a top, perspective view of the removable cartridge 300. The top 350 of the removable cartridge 300 can be coupled to any of the cartridge walls 310, 320, 330, 332 by one or more hinges 352, as depicted in FIG. 5. The hinge 352, if a fold, can be formed in the paperboard or other material that is used to make the top 350 and at least the cartridge wall 310, 320, 330, or 332 coupled thereto. For example, the hinge 352 can be a fold or crease disposed between and coupling together the top 350 and the cartridge wall 320. Alternatively, other types of hinges, not shown, could be coupled to the top 350 and the respective cartridge wall 310, 320, 330, or 332 that the top 350 is coupled thereto. In one example, a paperboard or plastic flap or tab can be adhered to both the top 350 and the cartridge wall 310, 320, 330, or 332. In another example, a paperboard flap or tab can be an integral portion of one of the top 350 or the cartridge wall 310, 320, 330, or 332 and can be coupled to the other. In another example, a metal or plastic pinned hinge can be adhered to both the top 350 and the cartridge wall 310, 320, 330, or 332.

The top 350 of the removable cartridge 300 can be disposed in an opened-position, as depicted in FIG. 3. The locking tab 314 can be inserted into a locking slot 226 can be defined by or otherwise formed in one of the housing walls 210, 220, 230, 232 or the interior wall 240 of the housing unit 200 in the second compartment 206. FIG. 3 depicts the locking tab 314 inserted into the locking slot 226 defined by the housing wall 220.

The litter 380 contained in the interior volume 302 of the removable cartridge 300 can be used by a variety of different animals, including, but not limited to, cats, dogs, ferrets, or rabbits. The litter 380 can be or include one or more litter materials. Illustrative litter materials can be or include, but is not limited to, one or more of animal litters, sand, soil, paper (e.g., virgin and/or recycled paper), wood shavings, corn cob media, nut shell media, seed husk media, polymeric absorbent material, inorganic matrix media, zeolite materials, carbonate and bicarbonate materials (e.g., sodium bicarbonate or potassium bicarbonate), or any mixture thereof. In some examples, the animal litter can include cat litter and shredded paper, such as recycled paper. In other examples, the animal litter can include cat litter and sodium bicarbonate.

An animal, such as a cat, can enter the animal litter system 100 via the first passageway 222 by passing over a first threshold 221 and into the first compartment 204. From inside the first compartment 204, the animal can enter into the litter 380 contained the removable cartridge 300 via the second passageway 224 by passing over a second threshold 223 and into the second compartment 206. Once the animal is finished depositing liquid and/or solid excrement waste in the litter 380, the animal will leave the second compartment 206 via the second passageway 224 by passing over the second threshold 223. Generally, the animal will abruptly leave the second compartment 206, such as by jumping from the litter 380 contained the removable cartridge 300, over the second threshold 223, and into the first compartment 204. Litter material and excrement waste can become stuck to, entrained on, or otherwise disposed on the animal's fur and/or paws, and can be carried out of the removable cartridge 300 upon movement of the animal. The animal litter system 100 can help keep at least a portion, if not all, of the dislodged litter material and excrement waste contained within the first and second compartments 204, 206.

The first passageway 222 and the second passageway 224 can be misaligned relative to each other in order to form a nonlinear or tortuous path between the center of the removable cartridge 300 and the center of the first passageway 222 via the center of the second passageway 224. Due, at least in part, to this nonlinear or tortuous path, upon leaving the second compartment 206, the animal must enter the first compartment 204 and change direction before leaving the animal litter system 100 via the first passageway 222. The abrupt landing and/or changing direction in the first compartment 204 helps provide dislodgement of any litter material and/or excrement waste contained or otherwise disposed on the animal.

FIGS. 1-4 depict that the first passageway 222 and the second passageway 224 are disposed perpendicular or substantially perpendicular to each other, such that angle (α₁), as illustrated in FIG. 2, is about 90°. Depending on the configuration and location of the removable cartridge 300, an angle (α₁) of about 45° to about 135° or greater can be used to provide a nonlinear or tortuous path between the center of the removable cartridge 300 and the center of the first passageway 222 via the center of the second passageway 224. In some examples, the first passageway 222 and the second passageway 224 can be disposed, positioned, or otherwise facing each other at an angle (α₁) of about 45°, about 50°, about 55°, or about 60° to about 70°, about 80°, about 90°, about 100°, about 110°, about 120°, about 125°, about 130°, about 135°, or greater. For example, the first passageway 222 and the second passageway 224 can be disposed relatively to each other at an angle (α₁) of about 45° to about 135°, about 50° to about 130°, about 60° to about 120°, about 70° to about 110°, about 80° to about 100°, or about 85° to about 95°. In one specific example, the first passageway 222 can be disposed, positioned, or otherwise facing at an angle (α₁) of about 45° to about 135° relative to the second passageway 224.

FIG. 1 depicts the first threshold 221 disposed below the first passageway 222 and the second threshold 223 disposed below the second passageway 224. The thresholds 221, 223 can help maintain litter 380 and other media from leaving the animal litter system 100. For example, if an animal leaves the litter 380 via the second passageway 224, then at least a portion of any dislodged litter material and/or excrement waste coming from the animal can be stopped by the second threshold 223 and the interior wall 240 and hence can be maintained in the second compartment 206 while the animal moves into the first compartment 204. Similarly, if an animal leaves the first compartment 204 via the first passageway 222, then at least a portion of any dislodged litter material and/or excrement waste coming from the animal can be stopped by the first threshold 221 and the housing wall 210 and hence can be maintained in the first compartment 204 while the animal advances outside of the animal litter system 100. Each of the thresholds 521, 223 and each of the passageways 222, 224 can independently have any shape or size. For example, each of the thresholds 221, 223 can independently be straight or rectangular and each of the upper portions of the passageways 222, 224 can independently be round or circular, as depicted in FIG. 1. In other examples, not shown, each of the thresholds 221, 223 can independently be round or circular and each of the upper portions of the passageways 222, 224 can independently be straight or rectangular.

Each of the thresholds 221, 223 can independently be or include a portion of the wall from which the passageway is formed or otherwise defined from. For example, the first threshold 221 can be or include a portion of the front housing wall 210 disposed below the first passageway 222. Similarly, the second threshold 223 can be or include a portion of the interior wall 240 disposed below the second passageway 224. Alternatively, the thresholds 221 and/or 223 can be or include additional barricade walls or steps coupled to any portion of the housing unit 200, including, but not limited to, the floor 260, the housing walls 210, 220, 230, 232, and/or the interior wall 240. Alternatively, the thresholds 221 and/or 223 can include one or more surface modifications adapted to contact the animal as the animal passes over the thresholds 221 and/or 223. For example, one or more brushes or protrusions (not shown) can be disposed on or otherwise integrated with the thresholds 221 and/or 223.

Each of the thresholds 221, 223 can independently have a height measured as extending perpendicular or substantially perpendicular from the floor 260 of the housing unit 200. Each of the thresholds 221, 223 can independently have a height of about 5 mm, about 10 mm, about 20 mm, about 30 mm, about 40 mm, or about 60 mm to about 70 mm, about 80 mm, about 90 mm, about 100 mm, about 110 mm, about 120 mm, about 130 mm, about 140 mm, about 150 mm, or greater. For example, each of the thresholds 221, 223 can independently have a height of about 5 mm to about 150 mm, about 10 mm to about 150 mm, about 20 mm to about 150 mm, about 30 mm to about 150 mm, about 40 mm to about 150 mm, about 60 mm to about 150 mm, about 80 mm to about 150 mm, about 100 mm to about 150 mm, about 40 mm to about 130 mm, about 60 mm to about 130 mm, about 80 mm to about 130 mm, about 100 mm to about 130 mm, about 40 mm to about 115 mm, about 60 mm to about 115 mm, about 80 mm to about 115 mm, about 100 mm to about 115 mm, about 40 mm to about 100 mm, about 60 mm to about 100 mm, or about 80 mm to about 100 mm.

One or more fluted layers 238 can be contained in the first compartment 204 and can be used to trap or otherwise contain dislodged litter material and/or clumps of animal excrement waste carried by the animal through the second passageway 224 from the removable cartridge 300. For example, the fluted layer 238 can be disposed on at least a portion of the floor 260 within the first compartment 204. Alternatively, at least a portion of the floor 260 in the first compartment 204 can be or include the fluted layer 238. The fluted layer 238 can be or include a corrugated layer of size A flutes, size B flutes, size C flutes, size E flutes, size F flutes, or any mixture thereof. The fluted layer 238 can contain the dislodged materials in the first compartment 204. Therefore, the fluted layer 238 can reduce or eliminate the dislodged materials from escaping the animal litter system 100 and contaminating the underlying surfaces outside of the animal litter system 100. In other examples, at least a portion of the floor 260 in the first compartment 204 can include a layer of artificial turf, including porous or high surface area artificial turf, for containing the dislodged materials in the first compartment 204.

In another embodiment, not shown, the first compartment 204 can include a removable piece, such as a tray or a removable panel disposed on at least a portion of the floor 260. The removable piece can be or include the fluted layers 238. In some examples, the removable piece can be lifted, pulled, or otherwise moved out of the first compartment 204 and any dislodged litter material and/or clumps of animal excrement waste contained thereon can be dumped back into the removable cartridge 300 or otherwise disposed of.

In use, once the top 350 of the removable cartridge 300 is in the opened-position, an animal entering the second compartment 206 from the first compartment 204 via the second passageway 224 can have access to the litter 380 contained in the removable cartridge 300. Also, when the animal litter system 100 is in use, the lid 250 on the housing unit 200 can be closed to reduce or eliminate any orders coming from any solid and/or liquid animal excrements disposed in the litter 380. The lid 250 on the housing unit 200 can also be closed so to effectively remove the sight of any animal excrement.

Periodically, whenever it is desirable to refresh the litter 380 that has become soiled, a user of the animal litter system 100 can remove clumps of solid and/or liquid animal excrement disposed in the litter 380. The lid 250 can be opened by inserting fingers or a hand into the gap 214 and lifting the lid 250. The clumps of animal excrement can be scooped or raked out of the litter 380 contained in the removable cartridge 300 with a tool, such as with a slotted scooper or a rake. Thereafter, the lid 250 can be closed again. Once the litter 380 has become too soiled to be refreshed or it is otherwise desirable to replace all of the litter 380, the removable cartridge 300 containing the soiled litter 380 can be replaced with another removable cartridge 300 containing fresh litter 380. The locking tab 314 can be removed from the locking slot 226 and the top 350 of the removable cartridge 300 can be closed. The top 350 of the removable cartridge 300 can be secured to the cartridge wall 310 via the locking tab 314 inserted through the locking slot 316. The removable cartridge 300 can be removed or otherwise displaced from the second compartment 206 by pulling the handle 312 until the cartridge 300 is brought outside of the housing unit 200 via the opening 212. Another removable cartridge containing fresh litter 380 can be inserted through the opening 212 and pushed into the second compartment 206. Thereafter, the top 350 of the removable cartridge 300 can be opened and the locking tab 314 can be inserted into the locking slot 226.

Each of the housing walls 210, 220, 230, 232, the interior wall 240, the lid 250, and the floor 260 of the housing unit 200 can independently include materials containing natural fibers, synthetic fibers, recycled fibers, or any mixture thereof. In some examples, each of the housing walls 210, 220, 230, 232, the interior wall 240, the lid 250, and the floor 260 can independently include one or more plastics, cellulosic fibers, or a mixture thereof. For example, each of the housing walls 210, 220, 230, 232, the interior wall 240, the lid 250, and the floor 260 can independently include one or more plastics. Illustrative plastics can be or include, but are not limited to, polyethylene (PE) (e.g., high-density polyethylene (HDPE) and/or low-density polyethylene (LDPE)), polypropylene (PP), polystyrene (PS), polyethylene terephthalate (PET), polyvinyl chloride (PVC), acrylic, nylon, polycarbonate, polylactic acid (PLA), one or more copolymers thereof, one or more terpolymers thereof, or any mixture thereof.

In other examples, each of the housing walls 210, 220, 230, 232, the interior wall 240, the lid 250, and the floor 260 can independently include materials containing cellulosic fibers, such as, but not limited to, paper, paperboard, fiberboard, cardboard, or any mixture thereof. Illustrative cellulosic fibers can include, but are not limited to, cotton fibers, lignocellulose fibers, pulp fibers, or any mixture thereof. Cellulosic fibers can include lignin, cellulose, hemi-cellulose material, or any mixture thereof. Pulp fibers can include cellulosic fibers in which at least a portion of the lignin has been removed. For example, in the pulp and paper industry, lignin-containing materials such as wood, straw, corn stalks, bagasse, and other vegetable and plant tissues can be processed to recover the cellulose or pulp via the well-known kraft or sulfate process or the well-known sulfite process. Exemplary pulp fibers can include, but are not limited to thermomechanical pulp fibers, chemithermomechanical pulp fibers, chemimechanical pulp fibers, refinermechanical pulp fibers, stone ground wood pulp fibers, peroxide mechanical pulp fibers, and the like.

Also, each of the housing walls 210, 220, 230, 232, the interior wall 240, the lid 250, and the floor 260 can independently include one or more waxes and/or one or more sizing agents. For example, one or more surfaces in the interior volume 202 of the housing unit 200 can have a wax coating disposed thereon. More specifically, one or more of the interior surfaces of the first compartment 204, including at least a portion of the interior surfaces of the housing walls 210, 220, and 230, the fluted layer 238, the interior wall 240, the lid 250, and the floor 260 can include the wax coating. Similarly, one or more of the interior surfaces of the second compartment 204, including at least a portion of the interior surfaces of the housing walls 210, 220, and 232, the interior wall 240, the lid 250, and the floor 260 can include the wax coating.

In some examples, each of the housing walls 210, 220, 230, 232, the fluted layer 238, the interior wall 240, the lid 250, and the floor 260 of the housing unit 200 can independently be or include one or more corrugated layers of size A flutes, size B flutes, size C flutes, size E flutes, size F flutes, or any mixture thereof. For example, each of the housing walls 210, 220, 230, 232, the fluted layer 238, the interior wall 240, and the lid 250 can independently be or include one or more corrugated layer of size B flutes or size F flutes. In other examples, each of the housing walls 210, 220, 230, 232, the fluted layer 238, the interior wall 240, the lid 250, and the floor 260 can independently be or include a corrugated layer having about 50 flutes per linear meter to about 1,000 flutes per linear meter.

In some examples, each of the housing walls 210, 220, 230, 232, the fluted layer 238, the interior wall 240, the lid 250, and the floor 260 of the housing unit 200 can independently be or include one or more corrugated layers having one or more pluralities of flutes. The height of the flutes in each of the housing walls 210, 220, 230, 232, the fluted layer 238 (e.g., the thickness of the fluted layer 238), the interior wall 240, the lid 250, and the floor 260 of the housing unit 200 can independently be about 0.5 mm, about 0.8 mm, about 1 mm, or about 1.4 mm to about 1.6 mm, about 1.8 mm, about 2 mm, about 2.4 mm, about 2.6 mm, about 2.8 mm, about 3 mm, about 3.5 mm, about 4 mm, about 5 mm, about 6 mm, or greater. For example, the height of the flutes can be about 0.5 mm to about 5 mm, about 0.5 mm to about 3 mm, about 1 mm to about 4 mm, about 1 mm to about 3 mm, about 1 mm to about 2 mm, about 1.6 mm to about 5 mm, or about 1.6 mm to about 3 mm.

The housing unit 200, each of the housing walls 210, 220, 230, 232, and the interior wall 240 can independently have a height (h₁) extending from the floor 260, as depicted in FIG. 4. The housing unit 200, each of the housing walls 210, 220, 230, 232, and the interior wall 240 can independently have a height (h₁) of about 30 cm, about 35 cm, or about 40 cm to about 50 cm, about 55 cm, about 60 cm, about 65 cm, about 70 cm, about 80 cm, about 90 cm, about 100 cm, about 120 cm, or about 150 cm. For example, the housing unit 200, each of the housing walls 210, 220, 230, 232, and the interior wall 240 can independently have a height (h₁) of about 30 cm to about 150 cm, about 35 cm to about 150 cm, about 35 cm to about 120 cm, about 35 cm to about 100 cm, about 35 cm to about 80 cm, about 35 cm to about 70 cm, about 35 cm to about 60 cm, about 35 cm to about 50 cm, about 40 cm to about 150 cm, about 40 cm to about 120 cm, about 40 cm to about 100 cm, about 40 cm to about 80 cm, about 40 cm to about 70 cm, about 40 cm to about 60 cm, about 40 cm to about 50 cm, about 50 cm to about 150 cm, about 50 cm to about 120 cm, about 50 cm to about 100 cm, about 50 cm to about 80 cm, about 50 cm to about 70 cm, or about 50 cm to about 60 cm.

The housing unit 200 and each of the housing walls 210, 220 can independently have a width (w₁), as depicted in FIG. 4. The housing unit 200 and each of the housing walls 210, 220 can independently have a width (w₁) of about 30 cm, about 35 cm, or about 40 cm to about 50 cm, about 55 cm, about 60 cm, about 65 cm, about 70 cm, about 80 cm, about 90 cm, about 100 cm, about 120 cm, or about 150 cm. For example, the housing unit 200 and each of the housing walls 210, 220 can independently have a width (w₁) of about 30 cm to about 150 cm, about 35 cm to about 150 cm, about 35 cm to about 120 cm, about 35 cm to about 100 cm, about 35 cm to about 80 cm, about 35 cm to about 70 cm, about 35 cm to about 60 cm, about 35 cm to about 50 cm, about 40 cm to about 150 cm, about 40 cm to about 120 cm, about 40 cm to about 100 cm, about 40 cm to about 80 cm, about 40 cm to about 70 cm, about 40 cm to about 60 cm, about 40 cm to about 50 cm, about 50 cm to about 150 cm, about 50 cm to about 120 cm, about 50 cm to about 100 cm, about 50 cm to about 80 cm, about 50 cm to about 70 cm, or about 50 cm to about 60 cm.

The housing unit 200, each of the housing walls 230, 232, and the interior wall 240 can independently have a length or depth (d₁), as depicted in FIG. 4. The housing unit 200, each of the housing walls 230, 232, and the interior wall 240 can independently have a depth (d₁) of about 20 cm, about 25 cm, about 30 cm, or about 35 cm to about 40 cm, about 45 cm, about 50 cm, about 55 cm, about 60 cm, about 65 cm, about 70 cm, about 80 cm, about 90 cm, or about 100 cm. For example, the housing unit 200, each of the housing walls 230, 232, and the interior wall 240 can independently have a depth (d₁) of about 20 cm to about 100 cm, about 25 cm to about 100 cm, about 25 cm to about 80 cm, about 25 cm to about 60 cm, about 25 cm to about 50 cm, about 25 cm to about 40 cm, about 30 cm to about 100 cm, about 30 cm to about 80 cm, about 30 cm to about 60 cm, about 30 cm to about 50 cm, about 30 cm to about 40 cm, about 35 cm to about 100 cm, about 35 cm to about 80 cm, about 35 cm to about 60 cm, about 35 cm to about 50 cm, or about 35 cm to about 40 cm.

The housing unit 200, such as the interior volume 202 therein, can have a volume capacity of about 10 L, about 30 L, about 50 L, about 60 L, about 70 L, about 80 L, about 90 L, or about 100 L to about 110 L, about 120 L, about 130 L, about 140 L, about 150 L, about 160 L, about 180 L, about 200 L, or greater. For example, the housing unit 200 can have a volume capacity of about 10 L to about 200 L, about 30 L to about 150 L, about 50 L to about 150 L, about 60 L to about 150 L, about 80 L to about 150 L, about 90 L to about 150 L, about 100 L to about 150 L, about 30 L to about 130 L, about 50 L to about 130 L, about 60 L to about 130 L, about 80 L to about 130 L, about 90 L to about 130 L, about 100 L to about 130 L, about 30 L to about 120 L, about 50 L to about 120 L, about 60 L to about 120 L, about 80 L to about 120 L, about 90 L to about 120 L, or about 100 L to about 120 L.

Each of the cartridge walls 310, 320, 330, 332, the top 350, and the bottom 360 of the removable cartridge 300 can independently include materials containing natural fibers, synthetic fibers, recycled fibers, or any mixture thereof. In some examples, each of the cartridge walls 310, 320, 330, 332, the top 350, and the bottom 360 can independently include one or more plastics, cellulosic fibers, or a mixture thereof. For example, each of the cartridge walls 310, 320, 330, 332, the top 350, and the bottom 360 can independently include one or more plastics.

Illustrative plastics can be or include, but are not limited to, polyethylene (PE) (e.g., high-density polyethylene (HDPE) and/or low-density polyethylene (LDPE)), polypropylene (PP), polystyrene (PS), polyethylene terephthalate (PET), polyvinyl chloride (PVC), acrylic, nylon, polycarbonate, polylactic acid (PLA), one or more copolymers thereof, one or more terpolymers thereof, or any mixture thereof. Illustrative cellulosic fibers can include, but are not limited to, cotton fibers, lignocellulose fibers, pulp fibers, or any mixture thereof. Cellulosic fibers can include lignin, cellulose, hemi-cellulose material, or any mixture thereof. Pulp fibers can include cellulosic fibers in which at least a portion of the lignin has been removed. For example, in the pulp and paper industry, lignin-containing materials such as wood, straw, corn stalks, bagasse, and other vegetable and plant tissues can be processed to recover the cellulose or pulp via the well-known kraft or sulfate process or the well-known sulfite process. Exemplary pulp fibers can include, but are not limited to thermomechanical pulp fibers, chemithermomechanical pulp fibers, chemimechanical pulp fibers, refinermechanical pulp fibers, stone ground wood pulp fibers, peroxide mechanical pulp fibers, and the like.

In other examples, each of the cartridge walls 310, 320, 330, 332, the top 350, and the bottom 360 can independently include materials containing cellulosic fibers, such as, but not limited to, paper, paperboard, fiberboard, cardboard, or any mixture thereof. Also, each of the cartridge walls 310, 320, 330, 332, the lid 250, and the bottom 360 can independently include one or more waxes and/or one or more sizing agents. For example, one or more surfaces in the interior volume 302 of the removable cartridge 300 can have a wax coating disposed thereon. More specifically, one or more of the interior surfaces of the interior volume 302, including at least a portion of the interior surfaces of the cartridge walls 310, 320, 330, 332, the top 350, and the bottom 360 can include the wax coating.

In some examples, each of the plurality of cartridge walls 310, 320, 330, 332, the top 350, and the bottom 360 of the removable cartridge 300 can independently be or include one or more corrugated layer of size A flutes, size B flutes, size C flutes, size E flutes, size F flutes, or any mixture thereof. For example, each of the cartridge walls 310, 320, 330, 332, the top 350, and the bottom 360 can independently be or include one or more corrugated layer of size B flutes or size F flutes. In other examples, each of the cartridge walls 310, 320, 330, 332, the top 350, and the bottom 360 can independently be or include a corrugated layer having about 50 flutes per linear meter to about 1,000 flutes per linear meter.

The removable cartridge 300 and each of the cartridge walls 310, 320, 330, 332 can independently have a height (h₂) extending from the bottom 360 of the removable cartridge 300, as depicted in FIG. 5. The removable cartridge 300 and each of the cartridge walls 310, 320, 330, 332 can independently have a height (h₂) of about 10 mm, about 30 mm, about 50 mm, or about 70 mm to about 80 mm, about 90 mm, about 100 mm, about 110 mm, about 120 mm, about 130 mm, about 140 mm, about 150 mm, about 160 mm, about 170 mm, about 180 mm, about 190 mm, about 200 mm, about 250 mm, or about 300 mm. For example, the removable cartridge 300 and each of the cartridge walls 310, 320, 330, 332 can independently have a height (h₂) of about 10 mm to about 300 mm, about 10 mm to about 200 mm, about 10 mm to about 150 mm, about 30 mm to about 300 mm, about 30 mm to about 200 mm, about 30 mm to about 150 mm, about 50 mm to about 300 mm, about 50 mm to about 250 mm, about 50 mm to about 200 mm, about 50 mm to about 150 mm, about 50 mm to about 100 mm, about 70 mm to about 150 mm, about 70 mm to about 130 mm, about 70 mm to about 110 mm, about 70 mm to about 100 mm, about 90 mm to about 150 mm, about 90 mm to about 130 mm, about 90 mm to about 110 mm, or about 90 mm to about 100 mm.

The removable cartridge 300 and each of the cartridge walls 310, 320 can independently have a width (w₂), as depicted in FIG. 5. The removable cartridge 300 and each of the cartridge walls 310, 320 can independently have a width (w₂) of about 10 cm, about 20 cm, about 25 cm, or about 30 cm to about 35 cm, about 40 cm, about 45 cm, about 50 cm, about 55 cm, about 60 cm, about 65 cm, about 70 cm, about 80 cm, about 90 cm, or about 100 cm. For example, the removable cartridge 300 and each of the cartridge walls 310, 320 can independently have a width (w₂) of about 10 cm to about 100 cm, about 20 cm to about 100 cm, about 20 cm to about 80 cm, about 20 cm to about 60 cm, about 20 cm to about 50 cm, about 20 cm to about 45 cm, about 20 cm to about 40 cm, about 20 cm to about 35 cm, about 30 cm to about 45 cm, about 30 cm to about 40 cm, about 30 cm to about 35 cm, about 25 cm to about 100 cm, about 25 cm to about 80 cm, about 25 cm to about 60 cm, about 25 cm to about 50 cm, about 25 cm to about 45 cm, about 25 cm to about 40 cm, about 25 cm to about 35 cm, about 30 cm to about 100 cm, about 30 cm to about 80 cm, about 30 cm to about 60 cm, about 30 cm to about 50 cm, about 30 cm to about 45 cm, about 30 cm to about 40 cm, or about 30 cm to about 35 cm.

The removable cartridge 300 and each of the cartridge walls 330, 332 can independently have a length or depth (d₂), as depicted in FIG. 5. The removable cartridge 300 and each of the cartridge walls 330, 332 can independently have a depth (d₂) of about 10 cm, about 20 cm, about 25 cm, about 30 cm, or about 35 cm to about 40 cm, about 45 cm, about 50 cm, about 55 cm, about 60 cm, about 65 cm, about 70 cm, about 80 cm, about 90 cm, or about 100 cm. For example, the removable cartridge 300 and each of the cartridge walls 330, 332 can independently have a depth (d₂) of about 10 cm to about 100 cm, about 20 cm to about 100 cm, about 25 cm to about 100 cm, about 25 cm to about 80 cm, about 25 cm to about 60 cm, about 25 cm to about 50 cm, about 25 cm to about 40 cm, about 30 cm to about 100 cm, about 30 cm to about 80 cm, about 30 cm to about 60 cm, about 30 cm to about 50 cm, about 30 cm to about 40 cm, about 35 cm to about 100 cm, about 35 cm to about 80 cm, about 35 cm to about 60 cm, about 35 cm to about 50 cm, or about 35 cm to about 40 cm.

The removable cartridge 300, such as the interior volume 302 therein, can have a volume capacity of about 1 L, about 3 L, about 5 L, about 6 L, about 8 L, or about 10 L to about 11 L, about 12 L, about 13 L, about 14 L, about 16 L, about 18 L, about 20 L, about 25 L, or about 30 L. For example, the removable cartridge 300 can have a volume capacity of about 1 L to about 30 L, about 3 L to about 30 L, about 5 L to about 30 L, about 5 L to about 25 L, about 5 L to about 20 L, about 5 L to about 15 L, about 10 L to about 30 L, about 10 L to about 25 L, about 10 L to about 20 L, about 10 L to about 15 L, about 12 L to about 30 L, about 12 L to about 25 L, about 12 L to about 20 L, about 12 L to about 15 L or about 12 L to about 14 L.

The housing unit 200, including the plurality of housing walls 210, 220, 230, 232, the fluted layer 238, the interior wall 240, the lid 250, and/or the floor 260, can be formed from a single piece of material or formed from multiple pieces of one or more types of materials. For example, a single piece of panel board can be cut and or folded to form the housing unit 200 containing any number of the housing walls 210, 220, 230, 232, the interior wall 240, the floor 260, and/or the lid 250. In some examples, the housing walls 210, 220, 230, 232, the interior wall 240, the floor 260, and the lid 250 can all be formed from the same piece of panel board and remain as a uniformed body to make the housing unit 200. In other examples, the housing walls 210, 220, 230, 232, the floor 260, and the lid 250 can be formed from the same piece of panel board and remain as a uniformed body and the interior wall 240 can be adhered thereto to make the housing unit 200. In other examples, the housing walls 210, 220, 230, 232, and the floor 260 can be formed from the same piece of panel board and remain as a uniformed body and the interior wall 240 and the lid 250 can be adhered thereto to make the housing unit 200. In other examples, each of the housing walls 210, 220, 230, 232, the interior wall 240, the floor 260, and the lid 250 can independently be formed from separate panels or pieces of panel board and subsequently, assembled and adhered together to make the housing unit 200.

The removable cartridge 300, including the plurality of cartridge walls 310, 320, 330, 332, the top 350 and/or the bottom 360, can be formed from a single piece of material or formed from multiple pieces of one or more types of materials. For example, a single piece of panel board can be cut and or folded to form the removable cartridge 300 containing any number of the cartridge walls 310, 320, 330, 332, the bottom 360, and/or the top 350. In some examples, the cartridge walls 310, 320, 330, 332, the bottom 360, and the top 350 can all be formed from the same piece of panel board and remain as a uniformed body to make the removable cartridge 300. In other examples, the cartridge walls 310, 320, 330, 332, and the bottom 360 can be formed from the same piece of panel board and remain as a uniformed body and the top 350 can be adhered thereto to make the removable cartridge 300. In other examples, each of the cartridge walls 310, 320, 330, 332, the bottom 360, and the top 350 can independently be formed from separate panels or pieces of panel board and subsequently, assembled and adhered together to make the removable cartridge 300.

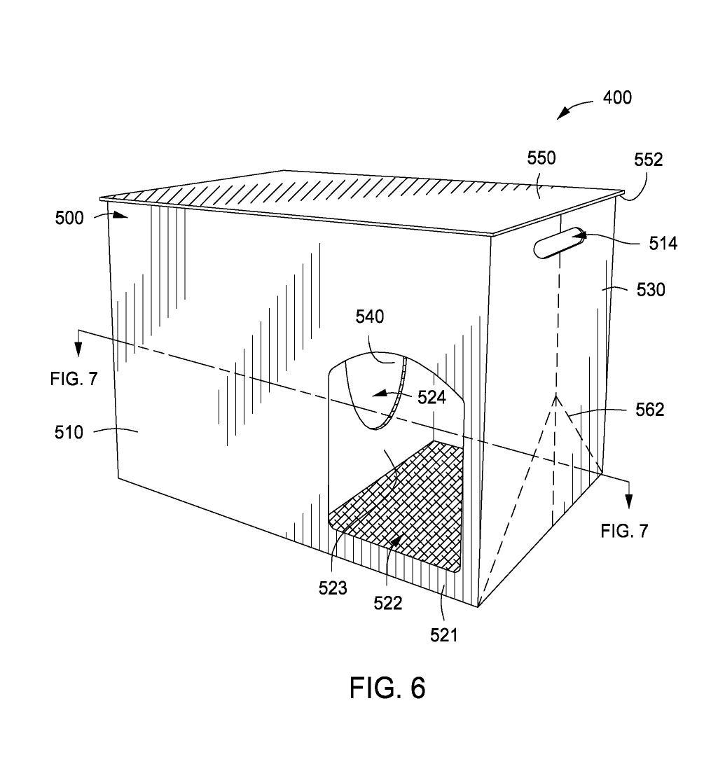

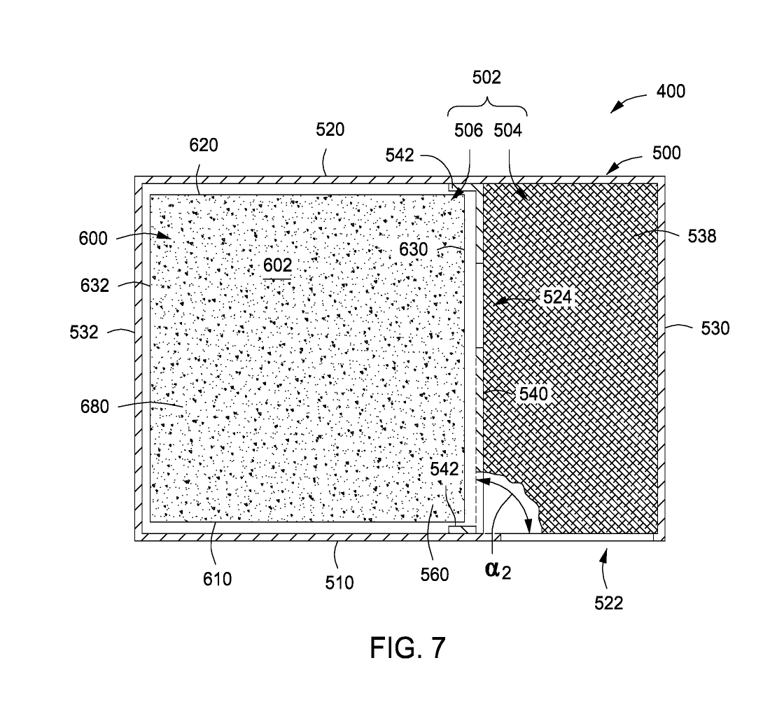

FIG. 6 depicts an animal litter system 400 that can include a housing unit 500 and a removable cartridge 600 and FIG. 7 depicts a cross-sectional view of the animal litter system 400 taken along line 7-7. The housing unit 500 can include a plurality of housing walls (four are shown 510, 520, 530, and 532), a floor 560, and a lid 550 at least partially or substantially enclosing an interior volume 502 of the housing unit 500. One or more interior walls 540 can be disposed in the housing unit 500. As depicted in FIGS. 6 and 7, the interior wall 540 can divide, partition, or otherwise separate the interior volume 502 of the housing unit 500 into two or more compartments, such as a first compartment 504 and a second compartment 506.

One or more passageways, such as a first passageway 522 and a second passageway 524, can be defined by or otherwise formed in any of the housing walls 510, 520, 530, 532 and/or the interior wall 540. As depicted in FIGS. 6 and 7, the first passageway can be defined by or otherwise formed in the housing wall 510 and the second passageway 524 can be defined by or otherwise formed in the interior wall 540. The passageways 522, 524 can provide an animal access to and from the various portions of the interior volume 502 of the housing unit 500. For example, the passageway 522 can provide access between an outside or exterior location of the housing unit 500 to the first compartment 504 through the housing wall 510. The second passageway 524 can provide access between the first compartment 504 and the second compartment 506 through the interior wall 540. In some examples, the first compartment 504 and the second compartment 506 can be integral or otherwise continuous between the housing walls 510, 520, 530, 532 and separated by the interior wall 540.

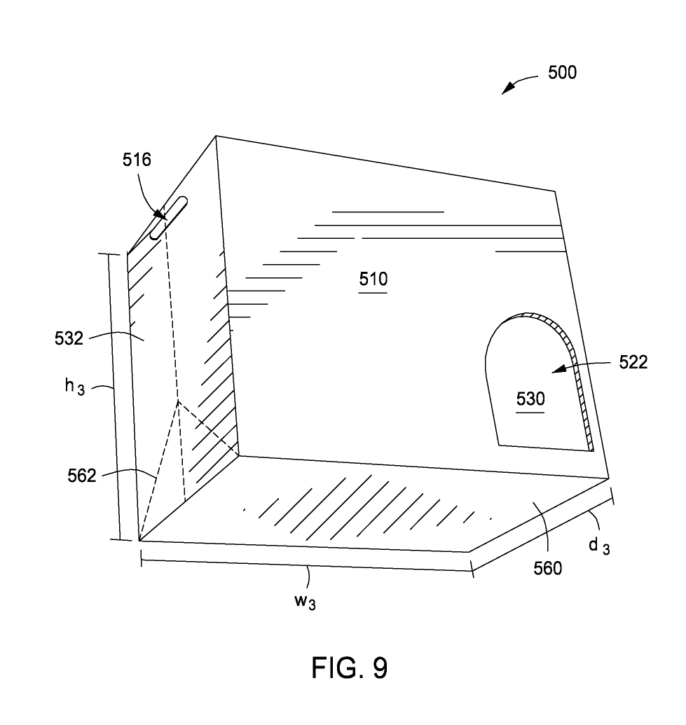

One or more handles 514, 516 can be disposed on, formed in, or otherwise defined by one or more of the housing walls 510, 520, 530, 532. For example, the handles 514, 516 can be defined by or otherwise formed in any of the housing walls 510, 520, 530, 532, such as the handle 514 defined by or formed in the housing wall 530 and the handle 516 defined by or formed in the housing wall 532, as depicted in FIGS. 6 and 9, respectively. Alternatively, although not shown, the handles 514, 516 can be disposed on an outer surface of the housing walls 510, 520, 530, 532.

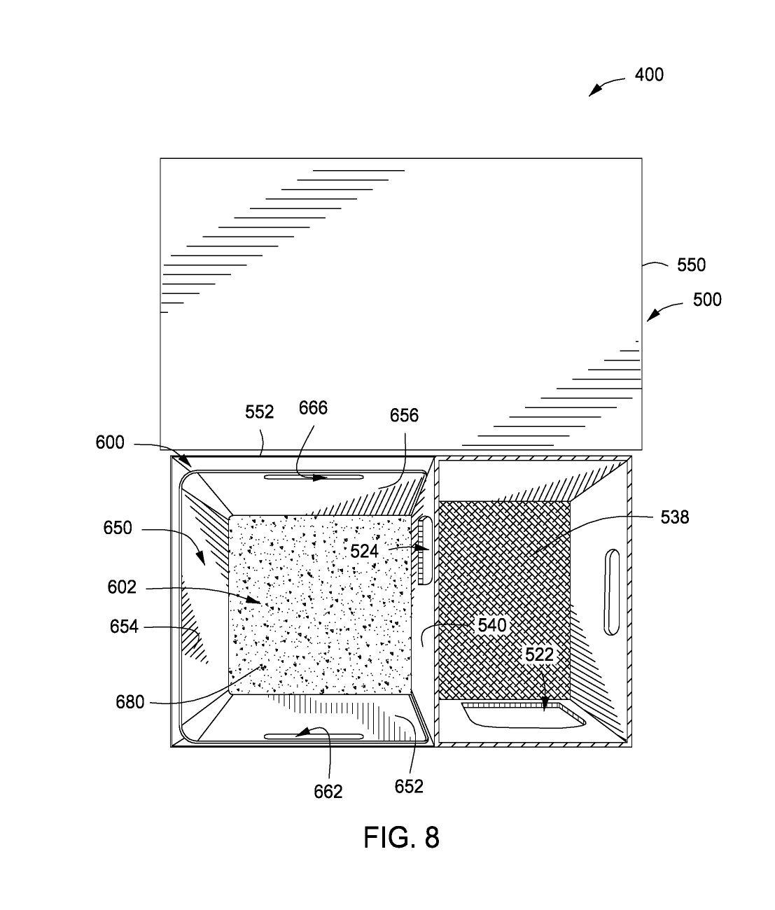

FIG. 8 depicts a top, isometric view of the animal litter system 400 that has the lid 550 opened on the housing unit 500. The lid 550 can be resting on and not coupled to the housing walls 510, 520, 530, 532. For example, the lid 550 can be a separate piece of the remaining of the housing unit 500 and can be disposed or otherwise placed on the housing walls 510, 520, 530, 532 to cover the first compartment 504 and the second compartment 506, as depicted in FIG. 6. Alternatively, the lid 550 of the housing unit 500 can be coupled to any of the housing walls 510, 520, 530, 532 by one or more hinges (not shown).

The hinge, if a fold, can be formed in the paperboard or other material that is used to make the lid 550 and at least the housing walls 510, 520, 530, 532 coupled thereto. For example, the lid 550 can be coupled to the housing wall 520 via a fold as the hinge (not shown). Alternatively, other types of hinges, not shown, could be coupled to the lid 550 and the respective housing wall 510, 520, 530, or 532 that the lid 550 is coupled thereto. In one example, a paperboard or plastic flap or tab can be adhered to both the lid 550 and the housing wall 510, 520, 530, or 532. In another example, a paperboard flap or tab can be an integral portion of one of the lid 550 or the housing wall 510, 520, 530, or 532 and can be coupled to the other. In another example, a metal or plastic pinned hinge can be adhered to both the lid 550 and the housing wall 510, 520, 530, or 532.

FIG. 9 depicts a bottom, perspective view of the housing unit 500. The plurality of housing walls 510, 520, 530, 532 can be coupled to and extend from the floor 560 to the lid 550—when the lid 550 on and in a closed-position. The housing unit 500 can include any number of pairs of folds, creases, perforations, locking tabs, and locking slots. In some examples, one or more folds 562 can be disposed on or defined by any of the housing walls 510, 520, 530, 532, the interior wall 540, the lid 550, and/or the floor 560. For example, one or more folds 562 can be disposed on or defined by the housing walls 530, 532, as depicted in FIGS. 6 and 9.

In some examples, the housing walls 510, 520, 530, 532 can include a front housing wall 510, a back housing wall 520, and at least one side housing wall 530, 532. The housing unit 500 can be configured to have the front housing wall 510, the back housing wall 520, and at least one side housing wall 530 or 532. The interior wall 540 can be coupled to at least one of the housing walls 510, 520, 530, 532 and/or the floor 560.

In one example, the interior wall 540 can be coupled to the front housing wall 510, the back housing wall 520, or both of the front housing wall 510 and the back housing wall 520. As depicted in FIG. 7, one or more flaps 542 can be adhered to one end of the interior wall 540 and the front housing wall 510 and another flap 542 can be adhered to the other end of the interior wall and the back housing wall 520. The flaps 542 can also be known as glue flaps or tabs. One or more adhesives or glues can be disposed on the flaps 542, the front housing wall 510, and/or the back housing wall 520 for adhering the interior wall 540 thereto. In another example, not shown, the interior wall 540 can be coupled to the side housing wall 530, the side housing wall 532, or both of the side housing walls 530, 532. In another example, not shown, the interior wall 540 can be coupled to the floor 560. The flap 542 can be located within the first compartment 504 or the second compartment 506. If interior wall 540 includes two or more flaps 542, the flaps 542 can be located in the first compartment 504, the second compartment 506, or some of the flaps, e.g., one, can be located in the first compartment 504 and some of the flaps 542, e.g., one, can be located in the second compartment 506.

FIGS. 7 and 8 further depicts that the removable cartridge 600 can include a plurality of cartridge walls 610, 620, 630, 632, and a guard 650. The cartridge walls 610, 620, 630, 632, the guard 650, and a bottom 660 can at least partially, substantially, or completely enclose an interior volume 602 (as depicted in FIGS. 7, 8, and 10) of the removable cartridge 600. Litter material, such as animal litter, can be disposed in the interior volume 602 of the removable cartridge 600.

The guard 650 of the removable cartridge 600 can include one or more sections 652, 654, 656 (three sections are shown) configured to provide additional containment for the litter material that may otherwise spill over from the housing walls 510, 532, 520, respectively. The guard 650 can be a uniform piece of material that includes each or all of the sections 652, 654, 656. Alternatively, each of the sections 652, 654, 656 can be or include separate pieces that form the guard 650.

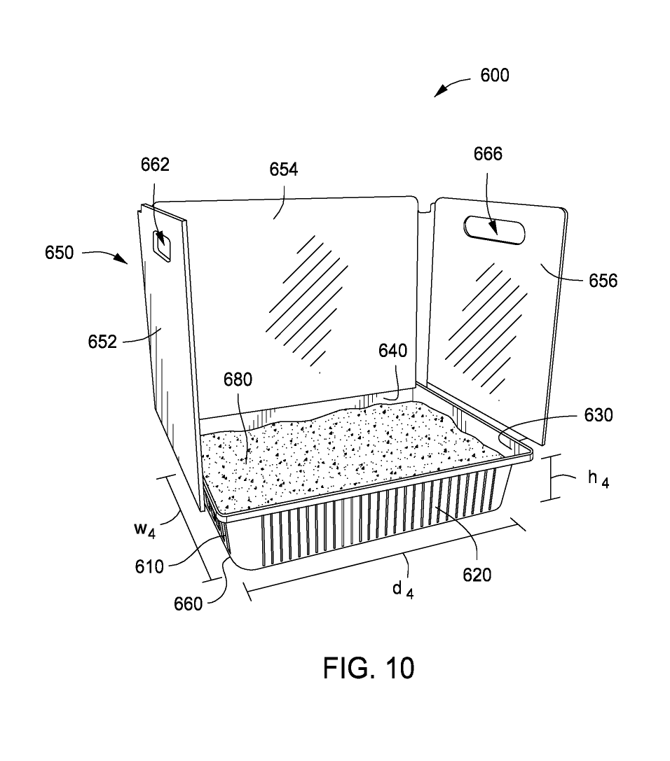

One or more handles 662, 666 can be disposed on, formed in, or otherwise defined by one or more of the sections 652, 654, 656 of the guard 650. For example, the handles 662, 666 can be defined by or otherwise formed in any of the sections 652, 654, 656 of the guard 650, such as the handle 662 defined by or formed in the section 652 and the handle 666 defined by or formed in the section 656, as depicted in FIGS. 8 and 10. Alternatively, although not shown, the handles 662, 666 can be disposed on an outer surface of the sections 652, 654, 656 of the guard 650.

The removable cartridge 600 can be configured to be disposed in the second compartment 506. Once disposed or otherwise placed in the second compartment 506, the handles 662, 666 can extend from the outer surface of the cartridge wall 610. The handles 662, 666 can be configured to be pulled or lifted for moving the removable cartridge 600 between the second compartment 506 and the outside of the housing unit 500 through the top.

The litter 680 contained in the interior volume 602 of the removable cartridge 600 can be used by a variety of different animals, including, but not limited to, cats, dogs, ferrets, or rabbits. The litter 680 can be or include one or more litter materials. Illustrative litter materials can be or include, but is not limited to, one or more of animal litters, sand, soil, paper (e.g., virgin and/or recycled paper), wood shavings, corn cob media, nut shell media, seed husk media, polymeric absorbent material, inorganic matrix media, zeolite materials, carbonate and bicarbonate materials (e.g., sodium bicarbonate or potassium bicarbonate), or any mixture thereof. In one example, the animal litter can include cat litter and shredded paper, such as recycled paper. In one example, the animal litter can include cat litter and sodium bicarbonate.

An animal, such as a cat, can enter the animal litter system 400 via the first passageway 522 by passing over a first threshold 521 and into the first compartment 504. From inside the first compartment 504, the animal can enter into the litter 680 contained the removable cartridge 600 via the second passageway 524 by passing over a second threshold 523 and into the second compartment 506. Once the animal is finished depositing liquid and/or solid excrement waste in the litter 680, the animal will leave the second compartment 506 via the second passageway 524 by passing over the second threshold 523. Generally, the animal will abruptly leave the second compartment 506, such as by jumping from the litter 680 contained the removable cartridge 600, over the second threshold 523, and into the first compartment 504. Litter material and excrement waste can become stuck to, entrained on, or otherwise disposed on the animal's fur and/or paws, and can be carried out of the removable cartridge 600 upon movement of the animal. The animal litter system 400 can help keep at least a portion, if not all, of the dislodged litter material and excrement waste contained within the first and second compartments 504, 506.

The first passageway 522 and the second passageway 524 can be misaligned relative to each other in order to form a nonlinear or tortuous path between the center of the removable cartridge 600 and the center of the first passageway 522 via the center of the second passageway 524. Due, at least in part, to this nonlinear or tortuous path, upon leaving the second compartment 506, the animal must enter the first compartment 504 and change direction before leaving the animal litter system 400 via the first passageway 522. The abrupt landing and/or changing direction in the first compartment 504 helps provide dislodgement of any litter material and/or excrement waste contained or otherwise disposed on the animal.

FIGS. 6-9 depict that the first passageway 522 and the second passageway 524 are disposed perpendicular or substantially perpendicular to each other, such that angle (α₂), as illustrated in FIG. 7, is about 90°. Depending on the configuration and location of the removable cartridge 600, an angle (α₂) of about 45° to about 135° or greater can be used to provide a nonlinear or tortuous path between the center of the removable cartridge 600 and the center of the first passageway 522 via the center of the second passageway 524. In some examples, the first passageway 522 and the second passageway 524 can be disposed, positioned, or otherwise facing each other at an angle (α₂) of about 45°, about 50°, about 55°, or about 60° to about 70°, about 80°, about 90°, about 100°, about 110°, about 120°, about 125°, about 130°, about 135°, or greater. For example, the first passageway 522 and the second passageway 524 can be disposed relatively to each other at an angle (α₂) of about 45° to about 135°, about 50° to about 130°, about 60° to about 120°, about 70° to about 110°, about 80° to about 100°, or about 85° to about 95°. In one specific example, the first passageway 522 can be disposed, positioned, or otherwise facing at an angle (α₂) of about 45° to about 135° relative to the second passageway 524.

FIG. 6 depicts the first threshold 521 disposed below the first passageway 522 and the second threshold 523 disposed below the second passageway 524. The thresholds 521, 523 can help maintain litter 680 and other media from leaving the animal litter system 400. For example, if an animal leaves the litter 680 via the second passageway 524, then at least a portion of any dislodged litter material and/or excrement waste coming from the animal can be stopped by the second threshold 523 and the interior wall 540 and hence can be maintained in the second compartment 506 while the animal moves into the first compartment 504. Similarly, if an animal leaves the first compartment 504 via the first passageway 522, then at least a portion of any dislodged litter material and/or excrement waste coming from the animal can be stopped by the first threshold 521 and the housing wall 510 and hence can be maintained in the first compartment 504 while the animal advances outside of the animal litter system 400. Each of the thresholds 521, 523 and each of the passageways 522, 524 can independently have any shape or size. For example, each of the thresholds 521, 523 can independently be rounded or circular and each of the upper portions of the passageways 522, 524 can independently be rounded or circular, as depicted in FIG. 6. In other examples, not shown, each of the thresholds 521, 523 can independently be straight or rectangular and each of the upper portions of the passageways 522, 524 can independently be straight or rectangular.

Each of the thresholds 521, 523 can independently be or include a portion of the wall from which the passageway is formed or otherwise defined from. For example, the first threshold 521 can be or include a portion of the front housing wall 510 disposed below the first passageway 522. Similarly, the second threshold 523 can be or include a portion of the interior wall 540 disposed below the second passageway 524. Alternatively, the thresholds 521 and/or 523 can be or include additional barricade walls or steps coupled to any portion of the housing unit 500, including, but not limited to, the floor 560, the housing walls 510, 520, 530, 532, and/or the interior wall 540. Alternatively, the thresholds 521 and/or 523 can include one or more surface modifications adapted to contact the animal as the animal passes over the thresholds 521 and/or 523. For example, one or more brushes or protrusions (not shown) can be disposed on or otherwise integrated with the thresholds 521 and/or 523.

Each of the thresholds 521, 523 can independently have a height measured as extending perpendicular or substantially perpendicular from the floor 560 of the housing unit 500. Each of the thresholds 521, 523 can independently have a height of about 5 mm, about 10 mm, about 20 mm, about 30 mm, about 40 mm, or about 60 mm to about 70 mm, about 80 mm, about 90 mm, about 100 mm, about 110 mm, about 120 mm, about 130 mm, about 140 mm, about 150 mm, or greater. For example, each of the thresholds 521, 523 can independently have a height of about 5 mm to about 150 mm, about 10 mm to about 150 mm, about 20 mm to about 150 mm, about 30 mm to about 150 mm, about 40 mm to about 150 mm, about 60 mm to about 150 mm, about 80 mm to about 150 mm, about 100 mm to about 150 mm, about 40 mm to about 130 mm, about 60 mm to about 130 mm, about 80 mm to about 130 mm, about 100 mm to about 130 mm, about 40 mm to about 115 mm, about 60 mm to about 115 mm, about 80 mm to about 115 mm, about 100 mm to about 115 mm, about 40 mm to about 100 mm, about 60 mm to about 100 mm, or about 80 mm to about 100 mm.

One or more fluted layers 538 can be contained in the first compartment 504 and can be used to trap or otherwise contain dislodged litter material and/or clumps of animal excrement waste carried by the animal through the second passageway 524 from the removable cartridge 600. For example, the fluted layer 538 can be disposed on at least a portion of the floor 560 within the first compartment 504. Alternatively, at least a portion of the floor 560 in the first compartment 504 can be or include the fluted layer 538. The fluted layer 538 can be or include a corrugated layer of size A flutes, size B flutes, size C flutes, size E flutes, size F flutes, or any mixture thereof. The fluted layer 538 can contain the dislodged materials in the first compartment 504. Therefore, the fluted layer 538 can reduce or eliminate the dislodged materials from escaping the animal litter system 400 and contaminating the underlying surfaces outside of the animal litter system 400. In other examples, at least a portion of the floor 560 in the first compartment 504 can include a layer of artificial turf, including porous or high surface area artificial turf, for containing the dislodged materials in the first compartment 504.

In another embodiment, not shown, the first compartment 504 can include a removable piece, such as a tray or a removable panel disposed on at least a portion of the floor 560. The removable piece can be or include the fluted layers 538. In some examples, the removable piece can be lifted, pulled, or otherwise moved out of the first compartment 504 and any dislodged litter material and/or clumps of animal excrement waste contained thereon can be dumped back into the removable cartridge 600 or otherwise disposed of.

In use, an animal entering the second compartment 506 from the first compartment 504 via the second passageway 524 can have access to the litter 680 contained in the removable cartridge 600. Also, when the animal litter system 400 is in use, the lid 550 on the housing unit 500 can be closed to reduce or eliminate any orders coming from any solid and/or liquid animal excrements disposed in the litter 680. The lid 550 on the housing unit 500 can also be closed so to effectively remove the sight of any animal excrement.

Periodically, whenever it is desirable to refresh the litter 680 that has become soiled, a user of the animal litter system 400 can remove clumps of solid and/or liquid animal excrement disposed in the litter 680. The lid 550 can be opened or removed by inserting fingers or a hand under one or more lips 552 and lifting the lid 550, as depicted in FIG. 6. The lip 552 of the lid 550 can extend away from any of one or more of the housing walls 510, 520, 530, 532. The clumps of animal excrement can be scooped or raked out of the litter 680 contained in the removable cartridge 600 with a tool, such as with a slotted scooper or a rake. Thereafter, the lid 550 can be closed again. Once the litter 680 has become too soiled to be refreshed or it is otherwise desirable to replace all of the litter 680, the removable cartridge 600 containing the soiled litter 680 can be replaced with another removable cartridge 600 containing fresh litter 680. The removable cartridge 600 can be removed or otherwise displaced from the second compartment 506 by lifting or pulling the handles 662, 666 until the cartridge 600 is brought outside of the housing unit 500 through the top. Another removable cartridge containing fresh litter 680 can be inserted into the second compartment 506.

Each of the housing walls 510, 520, 530, 532, the interior wall 540, the lid 550, and the floor 560 of the housing unit 500 can independently include materials containing natural fibers, synthetic fibers, recycled fibers, or any mixture thereof. In some examples, each of the housing walls 510, 520, 530, 532, the interior wall 540, the lid 550, and the floor 560 can independently include one or more plastics, cellulosic fibers, or a mixture thereof. For example, each of the housing walls 510, 520, 530, 532, the interior wall 540, the lid 550, and the floor 560 can independently include one or more plastics. Illustrative plastics can be or include, but are not limited to, polyethylene (PE) (e.g., high-density polyethylene (HDPE) and/or low-density polyethylene (LDPE)), polypropylene (PP), polystyrene (PS), polyethylene terephthalate (PET), polyvinyl chloride (PVC), acrylic, nylon, polycarbonate, polylactic acid (PLA), one or more copolymers thereof, one or more terpolymers thereof, or any mixture thereof.

In other examples, each of the housing walls 510, 520, 530, 532, the interior wall 540, the lid 550, and the floor 560 can independently include materials containing cellulosic fibers, such as, but not limited to, paper, paperboard, fiberboard, cardboard, or any mixture thereof. Illustrative cellulosic fibers can include, but are not limited to, cotton fibers, lignocellulose fibers, pulp fibers, or any mixture thereof. Cellulosic fibers can include lignin, cellulose, hemi-cellulose material, or any mixture thereof. Pulp fibers can include cellulosic fibers in which at least a portion of the lignin has been removed. For example, in the pulp and paper industry, lignin-containing materials such as wood, straw, corn stalks, bagasse, and other vegetable and plant tissues can be processed to recover the cellulose or pulp via the well-known kraft or sulfate process or the well-known sulfite process. Exemplary pulp fibers can include, but are not limited to thermomechanical pulp fibers, chemithermomechanical pulp fibers, chemimechanical pulp fibers, refinermechanical pulp fibers, stone ground wood pulp fibers, peroxide mechanical pulp fibers, and the like.

Also, each of the housing walls 510, 520, 530, 532, the interior wall 540, the lid 550, and the floor 560 can independently include one or more waxes and/or one or more sizing agents. For example, one or more surfaces in the interior volume 502 of the housing unit 500 can have a wax coating disposed thereon. More specifically, one or more of the interior surfaces of the first compartment 504, including at least a portion of the interior surfaces of the housing walls 510, 520, and 530, the fluted layer 538, the interior wall 540, the lid 550, and the floor 560 can include the wax coating. Similarly, one or more of the interior surfaces of the second compartment 504, including at least a portion of the interior surfaces of the housing walls 510, 520, and 532, the interior wall 540, the lid 550, and the floor 560 can include the wax coating.

In some examples, each of the housing walls 510, 520, 530, 532, the fluted layer 538, the interior wall 540, the lid 550, and the floor 560 of the housing unit 500 can independently be or include one or more corrugated layers of size A flutes, size B flutes, size C flutes, size E flutes, size F flutes, or any mixture thereof. For example, each of the housing walls 510, 520, 530, 532, the fluted layer 538, the interior wall 540, and the lid 550 can independently be or include one or more corrugated layer of size B flutes or size F flutes. In other examples, each of the housing walls 510, 520, 530, 532, the fluted layer 538, the interior wall 540, the lid 550, and the floor 560 can independently be or include a corrugated layer having about 50 flutes per linear meter to about 1,000 flutes per linear meter.

In some examples, each of the housing walls 510, 520, 530, 532, the fluted layer 538, the interior wall 540, the lid 550, and the floor 560 of the housing unit 500 can independently be or include one or more corrugated layers having one or more pluralities of flutes. The height of the flutes in each of the housing walls 510, 520, 530, 532, the fluted layer 538 (e.g., the thickness of the fluted layer 538), the interior wall 540, the lid 550, and the floor 560 of the housing unit 500 can independently be about 0.5 mm, about 0.8 mm, about 1 mm, or about 1.4 mm to about 1.6 mm, about 1.8 mm, about 2 mm, about 2.4 mm, about 2.6 mm, about 2.8 mm, about 3 mm, about 3.5 mm, about 4 mm, about 5 mm, about 6 mm, or greater. For example, the height of the flutes can be about 0.5 mm to about 5 mm, about 0.5 mm to about 3 mm, about 1 mm to about 4 mm, about 1 mm to about 3 mm, about 1 mm to about 2 mm, about 1.6 mm to about 5 mm, or about 1.6 mm to about 3 mm.

The housing unit 500, each of the housing walls 510, 520, 530, 532, and the interior wall 540 can independently have a height (h₃) extending from the floor 560, as depicted in FIG. 9. The housing unit 500, each of the housing walls 510, 520, 530, 532, and the interior wall 540 can independently have a height (h₃) of about 30 cm, about 35 cm, or about 40 cm to about 50 cm, about 55 cm, about 60 cm, about 65 cm, about 70 cm, about 80 cm, about 90 cm, about 100 cm, about 120 cm, or about 150 cm. For example, the housing unit 500, each of the housing walls 510, 520, 530, 532, and the interior wall 540 can independently have a height (h₃) of about 30 cm to about 150 cm, about 35 cm to about 150 cm, about 35 cm to about 120 cm, about 35 cm to about 100 cm, about 35 cm to about 80 cm, about 35 cm to about 70 cm, about 35 cm to about 60 cm, about 35 cm to about 50 cm, about 40 cm to about 150 cm, about 40 cm to about 120 cm, about 40 cm to about 100 cm, about 40 cm to about 80 cm, about 40 cm to about 70 cm, about 40 cm to about 60 cm, about 40 cm to about 50 cm, about 50 cm to about 150 cm, about 50 cm to about 120 cm, about 50 cm to about 100 cm, about 50 cm to about 80 cm, about 50 cm to about 70 cm, or about 50 cm to about 60 cm.

The housing unit 500 and each of the housing walls 510, 520 can independently have a width (w₃), as depicted in FIG. 9. The housing unit 500 and each of the housing walls 510, 520 can independently have a width (w₃) of about 30 cm, about 35 cm, or about 40 cm to about 50 cm, about 55 cm, about 60 cm, about 65 cm, about 70 cm, about 80 cm, about 90 cm, about 100 cm, about 120 cm, or about 150 cm. For example, the housing unit 500 and each of the housing walls 510, 520 can independently have a width (w₃) of about 30 cm to about 150 cm, about 35 cm to about 150 cm, about 35 cm to about 120 cm, about 35 cm to about 100 cm, about 35 cm to about 80 cm, about 35 cm to about 70 cm, about 35 cm to about 60 cm, about 35 cm to about 50 cm, about 40 cm to about 150 cm, about 40 cm to about 120 cm, about 40 cm to about 100 cm, about 40 cm to about 80 cm, about 40 cm to about 70 cm, about 40 cm to about 60 cm, about 40 cm to about 50 cm, about 50 cm to about 150 cm, about 50 cm to about 120 cm, about 50 cm to about 100 cm, about 50 cm to about 80 cm, about 50 cm to about 70 cm, or about 50 cm to about 60 cm.

The housing unit 500, each of the housing walls 530, 532, and the interior wall 540 can independently have a length or depth (d₃), as depicted in FIG. 9. The housing unit 500, each of the housing walls 530, 532, and the interior wall 540 can independently have a depth (d₃) of about 20 cm, about 25 cm, about 30 cm, or about 35 cm to about 40 cm, about 45 cm, about 50 cm, about 55 cm, about 60 cm, about 65 cm, about 70 cm, about 80 cm, about 90 cm, or about 100 cm. For example, the housing unit 500, each of the housing walls 530, 532, and the interior wall 540 can independently have a depth (d₃) of about 20 cm to about 100 cm, about 25 cm to about 100 cm, about 25 cm to about 80 cm, about 25 cm to about 60 cm, about 25 cm to about 50 cm, about 25 cm to about 40 cm, about 30 cm to about 100 cm, about 30 cm to about 80 cm, about 30 cm to about 60 cm, about 30 cm to about 50 cm, about 30 cm to about 40 cm, about 35 cm to about 100 cm, about 35 cm to about 80 cm, about 35 cm to about 60 cm, about 35 cm to about 50 cm, or about 35 cm to about 40 cm.

The housing unit 500, such as the interior volume 502 therein, can have a volume capacity of about 10 L, about 30 L, about 50 L, about 60 L, about 70 L, about 80 L, about 90 L, or about 100 L to about 110 L, about 120 L, about 130 L, about 140 L, about 150 L, about 160 L, about 180 L, about 200 L, or greater. For example, the housing unit 500 can have a volume capacity of about 10 L to about 200 L, about 30 L to about 150 L, about 50 L to about 150 L, about 60 L to about 150 L, about 80 L to about 150 L, about 90 L to about 150 L, about 100 L to about 150 L, about 30 L to about 130 L, about 50 L to about 130 L, about 60 L to about 130 L, about 80 L to about 130 L, about 90 L to about 130 L, about 100 L to about 130 L, about 30 L to about 120 L, about 50 L to about 120 L, about 60 L to about 120 L, about 80 L to about 120 L, about 90 L to about 120 L, or about 100 L to about 120 L.

Each of the cartridge walls 610, 620, 630, 632, and the bottom 660 of the removable cartridge 600 and each of the sections 652, 654, 656 of the guard 650 can independently include materials containing natural fibers, synthetic fibers, recycled fibers, or any mixture thereof. In some examples, each of the cartridge walls 610, 620, 630, 632, the bottom 660, and each of the sections 652, 654, 656 can independently include one or more plastics, cellulosic fibers, or a mixture thereof. For example, each of the cartridge walls 610, 620, 630, 632, the bottom 660, and each of the sections 652, 654, 656 can independently include one or more plastics.

Illustrative plastics can be or include, but are not limited to, polyethylene (PE) (e.g., high-density polyethylene (HDPE) and/or low-density polyethylene (LDPE)), polypropylene (PP), polystyrene (PS), polyethylene terephthalate (PET), polyvinyl chloride (PVC), acrylic, nylon, polycarbonate, polylactic acid (PLA), one or more copolymers thereof, one or more terpolymers thereof, or any mixture thereof. The removable cartridge 600 can be or include, but is not limited to, a plastic tray, a plastic container, a plastic pan, or any other plastic containing device that is suitable for holding litter 680.

Illustrative cellulosic fibers can be or include, but are not limited to, cotton fibers, lignocellulose fibers, pulp fibers, or any mixture thereof. Cellulosic fibers can include lignin, cellulose, hemi-cellulose material, or any mixture thereof. Pulp fibers can include cellulosic fibers in which at least a portion of the lignin has been removed. For example, in the pulp and paper industry, lignin-containing materials such as wood, straw, corn stalks, bagasse, and other vegetable and plant tissues can be processed to recover the cellulose or pulp via the well-known kraft or sulfate process or the well-known sulfite process. Exemplary pulp fibers can include, but are not limited to thermomechanical pulp fibers, chemithermomechanical pulp fibers, chemimechanical pulp fibers, refinermechanical pulp fibers, stone ground wood pulp fibers, peroxide mechanical pulp fibers, and the like.

In other examples, each of the cartridge walls 610, 620, 630, 632, and the bottom 660 of the removable cartridge 600 and each of the sections 652, 654, 656 of the guard 650 can independently include materials containing cellulosic fibers, such as, but not limited to, paper, paperboard, fiberboard, cardboard, or any mixture thereof. Also, each of the cartridge walls 610, 620, 630, 632, the bottom 660, and each of the sections 652, 654, 656 can independently include one or more waxes and/or one or more sizing agents. For example, one or more surfaces in the interior volume 602 of the removable cartridge 600 can have a wax coating disposed thereon. More specifically, one or more of the interior surfaces of the interior volume 602, including at least a portion of the interior surfaces of the cartridge walls 610, 620, 630, 632, the bottom 660, and the sections 652, 654, 656 can include the wax coating.

In some examples, each of the cartridge walls 610, 620, 630, 632, and the bottom 660 of the removable cartridge 600 and each of the sections 652, 654, 656 of the guard 650 can independently be or include one or more corrugated layer of size A flutes, size B flutes, size C flutes, size E flutes, size F flutes, or any mixture thereof. For example, each of the cartridge walls 610, 620, 630, 632, the bottom 660, and each of the sections 652, 654, 656 can independently be or include one or more corrugated layer of size B flutes or size F flutes. In other examples, each of the cartridge walls 610, 620, 630, 632, the bottom 660, and each of the sections 652, 654, 656 can independently be or include a corrugated layer having about 50 flutes per linear meter to about 1,000 flutes per linear meter.

The removable cartridge 600 and each of the cartridge walls 610, 620, 630, 632 can independently have a height (h₄) extending from the bottom 660 of the removable cartridge 600, as depicted in FIG. 10. The removable cartridge 600 and each of the cartridge walls 610, 620, 630, 632 can independently have a height (h₄) of about 10 mm, about 30 mm, about 50 mm, or about 70 mm to about 80 mm, about 90 mm, about 100 mm, about 110 mm, about 120 mm, about 130 mm, about 140 mm, about 150 mm, about 160 mm, about 170 mm, about 180 mm, about 190 mm, about 200 mm, about 250 mm, or about 300 mm. For example, the removable cartridge 600 and each of the cartridge walls 610, 620, 630, 632 can independently have a height (h₄) of about 10 mm to about 300 mm, about 10 mm to about 200 mm, about 10 mm to about 150 mm, about 30 mm to about 300 mm, about 30 mm to about 200 mm, about 30 mm to about 150 mm, about 50 mm to about 300 mm, about 50 mm to about 250 mm, about 50 mm to about 200 mm, about 50 mm to about 150 mm, about 50 mm to about 100 mm, about 70 mm to about 150 mm, about 70 mm to about 130 mm, about 70 mm to about 110 mm, about 70 mm to about 100 mm, about 90 mm to about 150 mm, about 90 mm to about 130 mm, about 90 mm to about 110 mm, or about 90 mm to about 100 mm.

The removable cartridge 600 and each of the cartridge walls 610, 620 can independently have a width (w₄), as depicted in FIG. 10. The removable cartridge 600 and each of the cartridge walls 610, 620 can independently have a width (w₄) of about 10 cm, about 20 cm, about 25 cm, or about 30 cm to about 35 cm, about 40 cm, about 45 cm, about 50 cm, about 55 cm, about 60 cm, about 65 cm, about 70 cm, about 80 cm, about 90 cm, or about 100 cm. For example, the removable cartridge 600 and each of the cartridge walls 610, 620 can independently have a width (w₄) of about 10 cm to about 100 cm, about 20 cm to about 100 cm, about 20 cm to about 80 cm, about 20 cm to about 60 cm, about 20 cm to about 50 cm, about 20 cm to about 45 cm, about 20 cm to about 40 cm, about 20 cm to about 35 cm, about 30 cm to about 45 cm, about 30 cm to about 40 cm, about 30 cm to about 35 cm, about 25 cm to about 100 cm, about 25 cm to about 80 cm, about 25 cm to about 60 cm, about 25 cm to about 50 cm, about 25 cm to about 45 cm, about 25 cm to about 40 cm, about 25 cm to about 35 cm, about 30 cm to about 100 cm, about 30 cm to about 80 cm, about 30 cm to about 60 cm, about 30 cm to about 50 cm, about 30 cm to about 45 cm, about 30 cm to about 40 cm, or about 30 cm to about 35 cm.

The removable cartridge 600 and each of the cartridge walls 330, 332 can independently have a length or depth (d₄), as depicted in FIG. 10. The removable cartridge 600 and each of the cartridge walls 330, 332 can independently have a depth (d₄) of about 10 cm, about 20 cm, about 25 cm, about 30 cm, or about 35 cm to about 40 cm, about 45 cm, about 50 cm, about 55 cm, about 60 cm, about 65 cm, about 70 cm, about 80 cm, about 90 cm, or about 100 cm. For example, the removable cartridge 600 and each of the cartridge walls 330, 332 can independently have a depth (d₄) of about 10 cm to about 100 cm, about 20 cm to about 100 cm, about 25 cm to about 100 cm, about 25 cm to about 80 cm, about 25 cm to about 60 cm, about 25 cm to about 50 cm, about 25 cm to about 40 cm, about 30 cm to about 100 cm, about 30 cm to about 80 cm, about 30 cm to about 60 cm, about 30 cm to about 50 cm, about 30 cm to about 40 cm, about 35 cm to about 100 cm, about 35 cm to about 80 cm, about 35 cm to about 60 cm, about 35 cm to about 50 cm, or about 35 cm to about 40 cm.

The removable cartridge 600, such as the interior volume 602 therein, can have a volume capacity of about 1 L, about 3 L, about 5 L, about 6 L, about 8 L, or about 10 L to about 11 L, about 12 L, about 13 L, about 14 L, about 16 L, about 18 L, about 20 L, about 25 L, or about 30 L. For example, the removable cartridge 600 can have a volume capacity of about 1 L to about 30 L, about 3 L to about 30 L, about 5 L to about 30 L, about 5 L to about 25 L, about 5 L to about 20 L, about 5 L to about 15 L, about 10 L to about 30 L, about 10 L to about 25 L, about 10 L to about 20 L, about 10 L to about 15 L, about 12 L to about 30 L, about 12 L to about 25 L, about 12 L to about 20 L, about 12 L to about 15 L or about 12 L to about 14 L.

The housing unit 500, including the plurality of housing walls 510, 520, 530, 532, the fluted layer 538, the interior wall 540, the lid 550, and/or the floor 560, can be formed from a single piece of material or formed from multiple pieces of one or more types of materials. For example, a single piece of panel board can be cut and or folded to form the housing unit 500 containing any number of the housing walls 510, 520, 530, 532, the interior wall 540, the floor 560, and/or the lid 550. In some examples, the housing walls 510, 520, 530, 532, the interior wall 540, the floor 560, and the lid 550 can all be formed from the same piece of panel board and remain as a uniformed body to make the housing unit 500. In other examples, the housing walls 510, 520, 530, 532, the floor 560, and the lid 550 can be formed from the same piece of panel board and remain as a uniformed body and the interior wall 540 can be adhered thereto to make the housing unit 500. In other examples, the housing walls 510, 520, 530, 532, and the floor 560 can be formed from the same piece of panel board and remain as a uniformed body and the interior wall 540 and the lid 550 can be adhered thereto to make the housing unit 500. In other examples, each of the housing walls 510, 520, 530, 532, the interior wall 540, the floor 560, and the lid 550 can independently be formed from separate panels or pieces of panel board and subsequently, assembled and adhered together to make the housing unit 500.

The removable cartridge 600, including the cartridge walls 610, 620, 630, 632, and/or the bottom 660, and/or the sections 652, 654, 656 of the guard 650, can be formed from a single piece of material or formed from multiple pieces of one or more types of materials. For example, a single piece of plastic or panel board can be cut and or folded to form the removable cartridge 600 containing any number of the cartridge walls 610, 620, 630, 632 and the bottom 660. Also, a single piece of plastic or panel board can be cut and or folded to form the sections 652, 654, 656 of the guard 650. In some examples, a single piece of plastic or panel board can be cut and or folded to form the cartridge walls 610, 620, 630, 632, the bottom 660, and the sections 652, 654, 656 of the guard 650. In some examples, the cartridge walls 610, 620, 630, 632, the bottom 660, and the sections 652, 654, 656 of the guard 650 can all be formed from the same piece of plastic or panel board and remain as a uniformed body to make the removable cartridge 600. In other examples, the cartridge walls 610, 620, 630, 632, and the bottom 660 can be formed from the same piece of panel board and remain as a uniformed body and the guard 650 can be adhered thereto to make the removable cartridge 600. In other examples, each of the cartridge walls 610, 620, 630, 632, the bottom 660, and each of the sections 652, 654, 656 of the guard 650 can independently be formed from separate panels or pieces of panel board and subsequently, assembled and adhered together to make the removable cartridge 600.

Each of the housing walls 210, 220, 230, 232, the fluted layer 238, the interior wall 240, the lid 250, and the floor 260 of the housing unit 200 and each of the cartridge walls 310, 320, 330, 332, the top 350, and the bottom 360 of the removable cartridge 300 can independently have a thickness. Also, each of the housing walls 510, 520, 530, 532, the fluted layer 538, the interior wall 540, the lid 550, and the floor 560 of the housing unit 500, each of the cartridge walls 610, 620, 630, 632 and the bottom 660 of the removable cartridge 600, and each of the sections 652, 654, 656 of the guard 650 can independently have a thickness. Each of the aforementioned components can independently have a thickness of about 0.5 mm, about 0.7 mm, about 0.9 mm, or about 1 mm to about 1.2 mm, about 1.5 mm, about 2 mm, about 2.5 mm, about 3 mm, about 3.5 mm, about 4 mm, about 4.5 mm, or about 5 mm. For example, the thickness can be about 0.5 mm to about 5 mm, about 0.9 mm to about 5 mm, about 1 mm to about 5 mm, about 1 mm to about 4 mm, about 1 mm to about 3 mm, or about 1 mm to about 2 mm.

Each of the housing walls 210, 220, 230, 232, the fluted layer 238, the interior wall 240, the lid 250, and the floor 260 of the housing unit 200 and each of the plurality of cartridge walls 310, 320, 330, 332, the top 350, and the bottom 360 of the removable cartridge 300 can independently have a basis weight. Also, each of the housing walls 510, 520, 530, 532, the fluted layer 538, the interior wall 540, the lid 550, and the floor 560 of the housing unit 500, each of the cartridge walls 610, 620, 630, 632 and the bottom 660 of the removable cartridge 600, and each of the sections 652, 654, 656 of the guard 650 can independently have a basis weight. Each of the aforementioned components can independently have a basis weight of about 50 g/m², about 100 g/m², or about 150 g/m² to about 175 g/m², about 200 g/m², about 250 g/m², about 300 g/m², about 350 g/m², or about 400 g/m². For example, the basis weight can be about 50 g/m² to about 400 g/m², about 100 g/m² to about 400 g/m², about 150 g/m² to about 400 g/m², about 50 g/m² to about 300 g/m², about 100 g/m² to about 300 g/m², about 150 g/m² to about 300 g/m², about 50 g/m² to about 200 g/m², about 100 g/m² to about 200 g/m², or about 150 g/m² to about 200 g/m².

In some examples, each of the housing walls 210, 220, 230, 232, the fluted layer 238, the interior wall 240, the lid 250, the floor 260, and/or other portions of the housing unit 200, and/or each of the plurality of cartridge walls 310, 320, 330, 332, the top 350, the bottom 360, and/or other portions of the removable cartridge 300 can independently include cellulosic fibers and can be made from or include panel board. In other embodiments, each of the housing walls 510, 520, 530, 532, the fluted layer 538, the interior wall 540, the lid 550, and the floor 560 of the housing unit 500, each of the cartridge walls 610, 620, 630, 632 and the bottom 660 of the removable cartridge 600, and each of the sections 652, 654, 656 of the guard 650 can independently include cellulosic fibers and can be made from or include panel board. The panel board can include a single layer, two or more layers, three or more layers, four or more layers, five or more layers, six or more layers, or seven or more layers. For example, the panel board can include an outer layer, one or more middle layers, and an inner layer.

The panel board can be made of one or more sheets, or panels, of any known material, e.g., a fiberboard including paperboard, corrugated board, cardboard, wood, plastic, or any combination thereof. For example, the panel board can be made of cardboard, paperboard, foam board, or other suitable material. The panel board can be cut or stamped from a larger sheet of material. As a cut-out, the panel board can have an outer boundary that is a hard edge. Cuts and/or folds in the panel board can be made to separate and/or distinguish the one or more support flaps, the one or more bases, the one or more support tabs, the one or more connection flaps, or any combination thereof from one another.

The material can include a single sheet or two or more layered sheets. The sheets can be flat, non-corrugated sheets, corrugated sheets, or a combination thereof. In some examples, the panel board can be a corrugated linerboard made of a paperboard material having a first side, a second side, and a thickness determined by a distance between the first and second side. The panel board can be a corrugated panel board that can include a first paperboard layer, a second paperboard layer, and a corrugated layer disposed between the first paperboard layer and the second paperboard layer. The corrugated panel board can include a first corrugating linerboard, a second corrugating linerboard, and a corrugated medium disposed therebetween. The corrugated medium can be bonded to the first and/or second linerboards by any suitable methods. For example, an adhesive can be used and located at the tips of the flutes of corrugated medium to bond the first and/or second linerboards to the corrugated medium. In other examples, a starch bond can be used to bond the first and/or second linerboards to corrugated medium, or a resin, such as DACREZ® resin from National Adhesives can be used as an additive to the starch in order to provide increased water/moisture resistance to the starch bond.

In some examples, each of the housing walls 210, 220, 230, 232, the fluted layer 238, the interior wall 240, the lid 250, the floor 260, and/or other portions of the housing unit 200, and/or each of the plurality of cartridge walls 310, 320, 330, 332, the top 350, the bottom 360, and/or other portions of the removable cartridge 300 can independently include one or more sizing agents. In other examples, each of the housing walls 510, 520, 530, 532, the fluted layer 538, the interior wall 540, the lid 550, and the floor 560 of the housing unit 500, each of the cartridge walls 610, 620, 630, 632 and the bottom 660 of the removable cartridge 600, and each of the sections 652, 654, 656 of the guard 650 can independently include one or more sizing agents. The sizing agent can improve moisture resistance of the panel board. The sizing agent can be or include, but is not limited to, one or more of a clay-based material, a rosin, a latex, a latex-based material, starch, a modified starch, gelatin, a wax, an acrylic copolymer, an alkyl ketene dimer (AKD), an alkyl succinic anhydride (ASA), a polyamide-epihalohydrin (PAE), a styrene maleic anhydride (SMA), a styrene acrylic emulsion (SAE), a styrene acrylic acid (SAA), an ethylene acrylic acid (EAA), a polyurethane (PUR), or any mixture thereof.

The sizing agent can be applied to one or more layers of the panel board as a coating, as a laminate, as a polymer film extrudate, or any other suitable method. In one example, the sizing agent can be applied as a coating, specifically a water-based coating. Suitable water-based coatings include, but are not limited to, those formulations based on SBR (styrene butadiene) polymers. For example, the coatings include, but are not limited to, VAPOR COAT® 340 coating and MICHEM® Coat 415 coating from Michelman, Inc.; TYKOTE® 1024 coating from Dow-Reichhold; EC442 coating from Enviro-coatings; NOVACOTE PC® 550G97 and 550G00 coatings from GP Chemicals; SPECTRAGUARD® 3003 coating from Spectra-Kote Corp.; and CARTASEAL® HFU coating from Clariant Corp. The material used to make the panel board can include the linerboard, the moisture-repellant coating, and/or the linerboard can have moisture-repellant properties as discussed and described in U.S. Pat. No. 8,512,850.

In some examples, the sizing agent can include one or more clays, one or more clay-based materials, one or more rosins, one or more rosin-based materials, one or more latex materials, one or more latex-based materials, one or more starches, one or more modified starches, one or more gelatins, one or more waxes, one or more acrylic copolymers, one or more alkyl ketene dimers, one or more alkyl succinic anhydrides, one or more styrene maleic anhydride copolymers, one or more styrene maleimides, one or more styrene acrylic emulsions, one or more styrene acrylic acids, one or more ethylene acrylic acids, polyurethane, one or more polyurethane compositions, or any mixture thereof.

The amount of sizing agent that can be applied to and/or incorporated in the panel board can widely vary. For example, the sizing agent can be applied to and/or incorporated in the panel board in an amount of about 1 lb/MSF (pounds per thousand square feet), about 2 lb/MSF, about 3 lb/MSF, about 4 lb/MSF, or about 5 lb/MSF to about 6 lb/MSF, about 7 lb/MSF, about 8 lb/MSF, about 9 lb/MSF, about 10 lb/MSF, about 11 lb/MSF, about 12 lb/MSF, about 13 lb/MSF, about 14 lb/MSF, about 15 lb/MSF, about 16 lb/MSF, about 17 lb/MSF, about 18 lb/MSF, about 19 lb/MSF, or about 20 lb/MSF or more. In another example, the sizing agent can be applied to and/or incorporated in the panel board in an amount of about 1 lb/MSF to about 6 lb/MSF, about 3 lb/MSF to about 10 lb/MSF, about 2 lb/MSF to about 8 lb/MSF, about 7 lb/MSF to about 15 lb/MSF, about 4 lb/MSF to about 12 lb/MSF, about 10 lb/MSF to about 18 lb/MSF, or about 1 lb/MSF to about 20 lb/MSF.

The panel board can have a water absorbency of about 0.05 g/m² (grams of water per square meter of the panel board), about 0.07 g/m², about 0.1 g/m², about 0.15 g/m², about 0.2 g/m², about 0.3 g/m², about 0.5 g/m², about 0.7 g/m², about 1 g/m², about 1.3 g/m², or about 1.5 g/m² to about 2 g/m², about 2.5 g/m², about 3 g/m², about 4 g/m², about 5 g/m², about 7 g/m², about 10 g/m², about 15 g/m², or about 20 g/m² or more, as measured according to the Cobb test for a time of 180 seconds. For example, the panel board can have a water absorbency of less than 50 g/m², less than 45 g/m², less than 40 g/m², less than 35 g/m², less than 30 g/m², less than 25 g/m², less than 20 g/m², less than 15 g/m², less than 10 g/m², less than 7 g/m², less than 5 g/m², less than 4.5 g/m², less than 4 g/m², less than 3.5 g/m², less than 3 g/m², less than 2.5 g/m², less than 2 g/m², less than 1.5 g/m², less than 1 g/m², less than 0.7 g/m², less than 0.5 g/m², less than 0.3 g/m², less than 0.1 g/m², less than 0.07 g/m², less than 0.05 g/m², less than 0.01 g/m², less than 0.007 g/m², less than 0.005 g/m², less than 0.003 g/m², less than 0.001 g/m², less than 0.0007 g/m², less than 0.0005 g/m², less than 0.0003 g/m², or less than 0.0001 g/m², as measured according to the Cobb test for a time of 180 seconds.

Embodiments of the present disclosure further relate to any one or more of the following paragraphs:

1. An animal litter system, comprising: a housing unit comprising: a plurality of housing walls, a floor, and a lid at least partially enclosing an interior volume of the housing unit; an interior wall disposed in the housing unit and dividing the interior volume of the housing unit into a first compartment and a second compartment, wherein each of the housing walls, the floor, the lid, and the interior wall of the housing unit independently comprises a plastic, cellulosic fibers, or a mixture thereof; a first passageway defined by a first housing wall, wherein the first passageway provides access between the first compartment and outside of the housing unit through the first housing wall; and a second passageway defined by the interior wall, wherein the second passageway provides access between the first compartment and the second compartment through the interior wall; and a removable cartridge comprising: a plurality of cartridge walls and a bottom at least partially enclosing an interior volume of the removable cartridge, wherein each of the plurality of cartridge walls and the bottom of the removable cartridge independently comprises a plastic, cellulosic fibers, or a mixture thereof; and a litter disposed in the interior volume of the removable cartridge, wherein the removable cartridge is configured to be at least partially disposed in the second compartment.

2. An animal litter system, comprising: a housing unit comprising: a plurality of housing walls coupled to and extending from a floor, wherein the plurality of housing walls and the floor at least partially enclose an interior volume of the housing unit; an interior wall disposed in the housing unit and dividing the interior volume of the housing unit into a first compartment and a second compartment, wherein each of the housing walls, the floor, and the interior wall of the housing unit independently comprises a plastic, cellulosic fibers, or a mixture thereof; a first passageway defined by a first housing wall, wherein the first passageway provides access between the first compartment and outside of the housing unit through the first housing wall; and a second passageway defined by the interior wall, wherein the second passageway provides access between the first compartment and the second compartment through the interior wall, wherein the second passageway has a threshold, and wherein the threshold has a height of about 10 mm to about 150 mm extending from the floor of the housing unit; and a removable cartridge comprising a litter disposed in an interior volume of the removable cartridge, wherein the removable cartridge is configured to be at least partially disposed in the second compartment.

3. An animal litter system, comprising: a housing unit comprising: a plurality of housing walls, a floor, and a lid at least partially enclosing an interior volume of the housing unit; an interior wall disposed in the housing unit and dividing the interior volume of the housing unit into a first compartment and a second compartment, wherein each of the housing walls, the floor, and the interior wall of the housing unit independently comprises cellulosic fibers; a first passageway defined by a first housing wall, wherein the first passageway provides access between the first compartment and outside of the housing unit through the first housing wall; and a second passageway defined by the interior wall, wherein the second passageway provides access between the first compartment and the second compartment through the interior wall; and a removable cartridge comprising: a plurality of cartridge walls and a bottom at least partially enclosing an interior volume of the removable cartridge, wherein each of the plurality of cartridge walls and the bottom independently comprises a plastic; and a litter disposed in the interior volume of the removable cartridge, wherein the removable cartridge is disposed in the second compartment and has a volume capacity of about 5 L to about 20 L.

4. An animal litter system, comprising: a housing unit comprising: a plurality of housing walls, a floor, and a lid at least partially enclosing an interior volume of the housing unit; an interior wall disposed in the housing unit and dividing the interior volume of the housing unit into a first compartment and a second compartment, wherein each of the housing walls, the floor, the lid, and the interior wall of the housing unit independently comprises a plastic, cellulosic fibers, or a mixture thereof; a first passageway defined by a first housing wall, wherein the first passageway provides access between the first compartment and outside of the housing unit through the first housing wall; a second passageway defined by the interior wall, wherein the second passageway provides access between the first compartment and the second compartment through the interior wall; and an opening defined by one of the plurality of housing walls, wherein the opening provides access between the second compartment and outside of the housing unit through the one of the plurality of housing walls; and a removable cartridge comprising: a plurality of cartridge walls and a bottom at least partially enclosing an interior volume of the removable cartridge, wherein each of the plurality of cartridge walls and the bottom of the removable cartridge independently comprises cellulosic fibers; and a litter disposed in the interior volume of the removable cartridge, wherein the removable cartridge is configured to be at least partially disposed in the second compartment.

5. An animal litter system, comprising: a housing unit comprising: a plurality of housing walls coupled to and extending from a floor, wherein the plurality of housing walls and the floor at least partially enclose an interior volume of the housing unit; an interior wall disposed in the housing unit and dividing the interior volume of the housing unit into a first compartment and a second compartment, wherein each of the housing walls, the floor, and the interior wall of the housing unit independently comprises a plastic, cellulosic fibers, or a mixture thereof; a first passageway defined by a first housing wall, wherein the first passageway provides access between the first compartment and outside of the housing unit through the first housing wall; a second passageway defined by the interior wall, wherein the second passageway provides access between the first compartment and the second compartment through the interior wall, wherein the second passageway has a threshold, and wherein the threshold has a height of about 10 mm to about 150 mm extending from the floor of the housing unit; and an opening defined by one of the plurality of housing walls, wherein the opening provides access between the second compartment and outside of the housing unit through the one of the plurality of housing walls; and a removable cartridge comprising a litter disposed in an interior volume of the removable cartridge, wherein the removable cartridge is configured to be at least partially disposed in the second compartment.

6. An animal litter system, comprising: a housing unit comprising: a plurality of housing walls, a floor, and a lid at least partially enclosing an interior volume of the housing unit; an interior wall disposed in the housing unit and dividing the interior volume of the housing unit into a first compartment and a second compartment, wherein each of the housing walls, the floor, the lid, and the interior wall of the housing unit independently comprises a plastic, cellulosic fibers, or a mixture thereof; a first passageway defined by a first housing wall, wherein the first passageway provides access between the first compartment and outside of the housing unit through the first housing wall; a second passageway defined by the interior wall, wherein the second passageway provides access between the first compartment and the second compartment through the interior wall; and an opening defined by one of the plurality of housing walls, wherein the opening provides access between the second compartment and outside of the housing unit through the one of the plurality of housing walls; and a removable cartridge comprising: a plurality of cartridge walls, a bottom, and a top at least partially enclosing an interior volume of the removable cartridge, wherein each of the plurality of cartridge walls, the bottom, and the top independently comprises cellulosic fibers; and a litter disposed in the interior volume of the removable cartridge, wherein the removable cartridge is disposed in the second compartment and has a volume capacity of about 5 L to about 20 L.

7. The system according to any one of paragraphs 1-6, wherein the removable cartridge further comprises a handle coupled to at least one of the plurality of cartridge walls.

8. The system according to any one of paragraphs 1-7, wherein the plastic comprises a polyethylene, a polypropylene, a polystyrene, a polyethylene terephthalate, a polyvinyl chloride, an acrylic, a nylon, a polycarbonate, a polylactic acid, any copolymer thereof, or any mixture thereof.

9. The system according to any one of paragraphs 1-8, wherein the removable cartridge comprises a plastic container.

10. The system according to any one of paragraphs 1-9, wherein the removable cartridge comprises a plastic container, and wherein the plastic container comprises a polyethylene, a polypropylene, a polystyrene, a polyethylene terephthalate, a polyvinyl chloride, an acrylic, a nylon, a polycarbonate, a polylactic acid, any copolymer thereof, or any mixture thereof.

11. The system according to any one of paragraphs 1-10, wherein the plurality of housing walls comprises a front wall, a back wall, and at least one side wall, and wherein the interior wall is coupled to at least one of the housing walls or the floor.

12. The system according to any one of paragraphs 1-11, wherein the interior wall is coupled to the front wall, the back wall, or both of the front wall and the back wall, and wherein the interior wall is coupled to the front wall or the back wall via one or more flaps adhered to the front wall or the back wall.

13. The system according to any one of paragraphs 1-12, wherein the plurality of housing walls comprises a front wall, a back wall, and at least one side wall, wherein the lid is not coupled to the front wall, the back wall, or the side walls, and wherein the lid is configured to be removed from the plurality of housing walls.

14. The system according to any one of paragraphs 1-13, wherein the removable cartridge further comprises a top, and wherein the plurality of cartridge walls, the top, and the bottom at least partially enclose the interior volume of the removable cartridge.

15. The system according to any one of paragraphs 1-14, wherein the top of the removable cartridge further comprises a locking tab configured to insert into a locking slot defined by one of the cartridge walls when the top of the removable cartridge is in a closed-position.

16. The system according to any one of paragraphs 1-15, wherein the top of the removable cartridge further comprises a locking tab configured to insert into a locking slot defined by one of the housing walls or the interior wall in the second compartment of the housing unit when the top of the removable cartridge is in an opened-position.

17. The system according to any one of paragraphs 1-16, wherein each of the plurality of cartridge walls, the top, and the bottom of the removable cartridge independently comprises paperboard, fiberboard, cardboard, or any mixture thereof.

18. The system according to any one of paragraphs 1-17, wherein at least one of the plurality of cartridge walls, the lid, and the bottom of the removable cartridge comprises a sizing agent.

19. The system according to any one of paragraphs 1-18, wherein each of the plurality of cartridge walls, the top, and the bottom of the removable cartridge independently comprises paperboard, fiberboard, cardboard, or any mixture thereof, and at least one of the plurality of cartridge walls, the lid, and the bottom of the removable cartridge comprises a sizing agent.

20. The system according to any one of paragraphs 1-19, wherein a fluted material is disposed on at least a portion of the floor.

21. The system according to any one of paragraphs 1-20, wherein at least a portion of the floor in the first compartment comprises a fluted material.

22. The system according to any one of paragraphs 1-21, wherein each of the housing walls, the floor, the lid, and the interior wall of the housing unit independently comprises paperboard, fiberboard, cardboard, or any mixture thereof.

23. The system according to any one of paragraphs 1-22, wherein at least one of the housing walls, the floor, the lid, or the interior wall of the housing unit comprises a sizing agent.

24. The system according to any one of paragraphs 1-23, wherein each of the housing walls, the floor, the lid, and the interior wall of the housing unit independently comprises paperboard, fiberboard, cardboard, or any mixture thereof, and at least one of the housing walls, the floor, the lid, or the interior wall of the housing unit comprises a sizing agent.

25. The system according to any one of paragraphs 1-24, wherein one or more surfaces in the interior volume of the housing unit comprise a wax coating disposed thereon.

26. The system according to any one of paragraphs 1-25, wherein the plurality of housing walls comprises a front wall, a back wall, and at least one side wall, and wherein the interior wall is coupled to at least one of the housing walls or the floor.

27. The system according to any one of paragraphs 1-26, wherein the interior wall is coupled to the front wall, the back wall, or both of the front wall and the back wall.

28. The system according to any one of paragraphs 1-27, wherein the interior wall is coupled to the front wall or the back wall via one or more flaps adhered to the front wall or the back wall.

29. The system according to any one of paragraphs 1-28, wherein the interior wall is coupled to the front wall, the back wall, or both of the front wall and the back wall, and wherein the interior wall is coupled to the front wall or the back wall via one or more flaps adhered to the front wall or the back wall.

30. The system according to any one of paragraphs 1-29, wherein the plurality of housing walls comprises a front wall, a back wall, and at least one side wall.

31. The system according to any one of paragraphs 1-30, wherein the plurality of housing walls comprises a front wall, a back wall, and at least one side wall, and wherein a gap is defined by an upper edge of the front wall or the at least one side wall.

32. The system according to any one of paragraphs 1-31, wherein the plurality of housing walls comprises a front wall, a back wall, and at least one side wall, wherein a gap is defined by an upper edge of the front wall or the at least one side wall, and wherein the lid is coupled to the back wall, is not coupled to the front wall or the side walls, and is configured to open away from the gap.

33. The system according to any one of paragraphs 1-32, wherein a handle is disposed on an outer surface of one of the plurality of cartridge walls.

34. The system according to any one of paragraphs 1-33, wherein each of the cartridge walls of the removable cartridge has a height of about 50 mm to about 150 mm extending from the bottom of the removable cartridge.

35. The system according to any one of paragraphs 1-34, wherein the removable cartridge has a volume capacity of about 5 L to about 20 L.

36. The system according to any one of paragraphs 1-35, wherein the litter disposed in the interior volume of the removable cartridge comprises cat litter.

37. The system according to any one of paragraphs 1-36, wherein a first threshold is disposed below the first passageway and a second threshold is disposed below the second passageway.

38. The system according to any one of paragraphs 1-37, wherein each of the first threshold and the second threshold independently has a height of about 10 mm to about 150 mm extending from the floor of the housing unit.

39. The system according to any one of paragraphs 1-38, wherein the first passageway is facing at an angle of about 45° to about 135° relative to the second passageway.

40. The system according to any one of paragraphs 1-39, wherein each of the plurality of cartridge walls and the bottom of the removable cartridge independently comprises a plastic.

41. The system according to any one of paragraphs 1-39, wherein each of the plurality of cartridge walls and the bottom of the removable cartridge independently comprises cellulosic fibers.

42. The system according to any one of paragraphs 1-40, wherein each of the housing walls, the floor, the lid, and the interior wall of the housing unit independently comprises a plastic.

43. The system according to any one of paragraphs 1-41, wherein each of the housing walls, the floor, the lid, and the interior wall of the housing unit independently comprises cellulosic fibers.

44. The system according to paragraph 40 or 42, wherein the plastic comprises a polyethylene, a polypropylene, a polystyrene, a polyethylene terephthalate, a polyvinyl chloride, an acrylic, a nylon, a polycarbonate, a polylactic acid, any copolymer thereof, or any mixture thereof.

45. The system according to paragraph 41 or 43, wherein the cellulosic fibers comprise lignin, cellulose, hemi-cellulose material, or any mixture thereof.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. And if applicable, all patents, test procedures, and other documents cited in this application are fully incorporated by reference to the extent such disclosure is not inconsistent with this application and for all jurisdictions in which such incorporation is permitted.

While the foregoing is directed to certain illustrative embodiments, other and further embodiments of the invention can be devised without departing from the basic scope thereof, and the scope thereof is determined by the claims that follow.

What is claimed is:

1. An animal litter system, comprising:
a housing unit comprising:
a plurality of housing walls, a floor, and a lid at least partially enclosing an interior volume of the housing unit;
an interior wall disposed in the housing unit and dividing the interior volume of the housing unit into a first compartment and a second compartment, wherein each of the housing walls, the floor, the lid, and the interior wall of the housing unit independently comprises a plastic, cellulosic fibers, or a mixture thereof;
a first passageway defined by a first housing wall, wherein the first passageway provides access between the first compartment and outside of the housing unit through the first housing wall; and
a second passageway defined by the interior wall, wherein the second passageway provides access between the first compartment and the second compartment through the interior wall; and
a removable cartridge comprising:
a plurality of cartridge walls and a bottom at least partially enclosing an interior volume of the removable cartridge, wherein each of the plurality of cartridge walls and the bottom of the removable cartridge independently comprises a plastic, cellulosic fibers, or a mixture thereof; and
a litter disposed in the interior volume of the removable cartridge, wherein the removable cartridge is configured to be at least partially disposed in the second compartment.

2. The system of claim 1, wherein the removable cartridge further comprises a handle coupled to at least one of the plurality of cartridge walls.

3. The system of claim 1, wherein the plastic comprises a polyethylene, a polypropylene, a polystyrene, a polyethylene terephthalate, a polyvinyl chloride, an acrylic, a nylon, a polycarbonate, a polylactic acid, any copolymer thereof, or any mixture thereof.

4. The system of claim 1, wherein a fluted material is disposed on at least a portion of the floor, or at least a portion of the floor in the first compartment comprises a fluted material.

5. The system of claim 1, wherein each of the housing walls, the floor, the lid, and the interior wall of the housing unit independently comprises paperboard, fiberboard, cardboard, or any mixture thereof, and at least one of the housing walls, the floor, the lid, or the interior wall of the housing unit comprises a sizing agent.

6. The system of claim 1, wherein one or more surfaces in the interior volume of the housing unit comprise a wax coating disposed thereon.

7. The system of claim 1, wherein the plurality of housing walls comprises a front wall, a back wall, and at least one side wall, and wherein the interior wall is coupled to at least one of the housing walls or the floor.

8. The system of claim 7, wherein the interior wall is coupled to the front wall, the back wall, or both of the front wall and the back wall, and wherein the interior wall is coupled to the front wall or the back wall via one or more flaps adhered to the front wall or the back wall.

9. The system of claim 1, wherein the plurality of housing walls comprises a front wall, a back wall, a first side wall, and a second side wall, and wherein a handle is disposed on or formed in the front wall, the back wall, the first side wall, or the second side wall.

10. The system of claim 1, wherein the plurality of housing walls comprises a front wall, a back wall, and at least one side wall, wherein the lid is not coupled to the front wall, the back wall, or the side walls, and wherein the lid is configured to be removed from the plurality of housing walls.

11. The system of claim 1, wherein each of the cartridge walls of the removable cartridge has a height of about 50 mm to about 150 mm extending from the bottom of the removable cartridge.

12. The system of claim 1, wherein the removable cartridge has a volume capacity of about 5 L to about 20 L.

13. The system of claim 1, wherein the litter disposed in the interior volume of the removable cartridge comprises cat litter.

14. The system of claim 1, wherein a first threshold is disposed below the first passageway and a second threshold is disposed below the second passageway, and wherein each of the first threshold and the second threshold independently has a height of about 10 mm to about 150 mm extending from the floor of the housing unit.

15. The system of claim 1, wherein each of the plurality of cartridge walls and the bottom of the removable cartridge independently comprises a plastic.

16. The system of claim 1, wherein the first passageway is facing at an angle of about 45° to about 135° relative to the second passageway.

17. An animal litter system, comprising:
a housing unit comprising:
a plurality of housing walls coupled to and extending from a floor, wherein the plurality of housing walls and the floor at least partially enclose an interior volume of the housing unit;
an interior wall disposed in the housing unit and dividing the interior volume of the housing unit into a first compartment and a second compartment, wherein each of the housing walls, the floor, and the interior wall of the housing unit independently comprises a plastic, cellulosic fibers, or a mixture thereof;
a first passageway defined by a first housing wall, wherein the first passageway provides access between the first compartment and outside of the housing unit through the first housing wall; and
a second passageway defined by the interior wall, wherein the second passageway provides access between the first compartment and the second compartment through the interior wall, wherein the second passageway has a threshold, and wherein the threshold has a height of about 10 mm to about 150 mm extending from the floor of the housing unit; and
a removable cartridge comprising a litter disposed in an interior volume of the removable cartridge, wherein the removable cartridge is configured to be at least partially disposed in the second compartment.

18. The system of claim 17, wherein the removable cartridge further comprises a handle coupled to at least one of the plurality of cartridge walls, wherein the removable cartridge comprises a plastic container, and wherein the plastic container comprises a polyethylene, a polypropylene, a polystyrene, a polyethylene terephthalate, a polyvinyl chloride, an acrylic, a nylon, a polycarbonate, a polylactic acid, any copolymer thereof, or any mixture thereof.

19. The system of claim 17, wherein a fluted material is disposed on at least a portion of the floor; or at least a portion of the floor in the first compartment comprises a fluted material.

20. An animal litter system, comprising:
a housing unit comprising:
a plurality of housing walls, a floor, and a lid at least partially enclosing an interior volume of the housing unit;
an interior wall disposed in the housing unit and dividing the interior volume of the housing unit into a first compartment and a second compartment, wherein each of the housing walls, the floor, and the interior wall of the housing unit independently comprises cellulosic fibers;
a first passageway defined by a first housing wall, wherein the first passageway provides access between the first compartment and outside of the housing unit through the first housing wall; and
a second passageway defined by the interior wall, wherein the second passageway provides access between the first compartment and the second compartment through the interior wall; and
a removable cartridge comprising:
a plurality of cartridge walls and a bottom at least partially enclosing an interior volume of the removable cartridge, wherein each of the plurality of cartridge walls and the bottom independently comprises a plastic; and
a litter disposed in the interior volume of the removable cartridge, wherein the removable cartridge is disposed in the second compartment and has a volume capacity of about 5 L to about 20 L.
